(19) United States
(12) Patent Application Publication
(10) Pub. No.: US 2014/0173120 A1
(43) Pub. Date: Jun. 19, 2014

(54) METHOD FOR ESTABLISHING COMMUNICATION, COMPUTER SYSTEM, AND COMPUTER

(71) Applicant: FUJITSU LIMITED, Kawasaki-shi (JP)

(72) Inventor: Hiroshi Noda, Ota (JP)

(73) Assignee: FUJITSU LIMITED, Kawasaki-shi (JP)

(21) Appl. No.: 14/183,578

(22) Filed: Feb. 19, 2014

Related U.S. Application Data
(63) Continuation of application No. PCT/JP2011/069222, filed on Aug. 25, 2011.

(51) Int. Cl. H04L 29/06; H04L 12/26

(52) U.S. Cl. CPC H04L 65/1069; H04L 43/10
USPC 709/227

(57) ABSTRACT

A method for establishing a communication between a plurality of computers and a data processing device through a network, the method including: reporting, when a change occurs in a communication state between the plurality of computers and the data processing device, the change in the communication state to another computer; recognizing, from among the plurality of computers, a computer which establishes a communication with the data processing device, based on a notice of the change in the communication state; and establishing, when a number of computers for which each of the plurality of computers recognizes to have established a communication with the data processing device is not greater than a predetermined prescribed number, a communication with the data processing device, with a request from the data processing device.

### CROSS-REFERENCE TO RELATED APPLICATION

This application is a continuation application of International Application PCT/JP2011/069222 filed on Aug. 25, 2011 and designated the U.S., the entire contents of which are incorporated herein by reference.

### FIELD

The embodiments discussed herein are related to a technology for establishing communications through a network between a plurality of computers and a data processing device.

### BACKGROUND

Many computer systems in which a plurality of computers is connected to a network are configured to separately manage each computer by using a console (a data processing device). It has been typical that a console is prepared for each computer. However, when a console is prepared for each computer, as the number of computers increases, the number of consoles increases. Therefore, a cost for consoles increases and so does an installation space for consoles. For operators, the operability is poor since they need to move in accordance with the computers to be managed. Accordingly, in recent years, a console is connected to a network to which a plurality of computers is connected.

When a console is connected to a network to which a plurality of computers is connected, the console may communicate with all the computers. Therefore, operators need not move in accordance with the computers to be managed.

In a computer system, there are some cases in which the number of computers is restricted to one from among a plurality of computers that actually communicate with a console. For example, some protocols (hereafter called “a first protocol” for conveniences) which are used to communicate between a console and a computer restrict the number of computers to only one in which a console may perform communications in parallel (simultaneously). In a computer system which employs the above mentioned first protocol, restricting the number of computers which may communicate in parallel with a console to only one is needed.

The first protocol was widely employed in a computer system in which a console is prepared for each computer. In such a computer system, changing a plurality of computers and a console such that they are connected to a network, while employing the first protocol is considered. In this case, it needs to restrict the number of computers to only one that may communicate with a console simultaneously.

As a conventional method for restricting establishing communications by a computer (communication targets of a computer), there is a method wherein a computer which acts as communication targets is set for each computer. In the conventional method, each computer restricts communication targets in accordance with a setting content. The setting content is made as changeable by a request from communication targets. With this, when the conventional method is employed, each computer may switch the communication targets, while it restricts the number of communication targets.

When this conventional method is employed in a computer system to restrict the number of computers capable of communicating with a console simultaneously to only one, a console may be set for only one of a plurality of computers. Switching computers for communicating with a console may be performed by communications between two computers. For example, a computer which has been communicating with a console (a computer setting a console as a communication target, hereafter called “a first computer” for convenience) subsequently sets a computer for communicating with a console (hereafter called “a second computer” for convenience) as a communication target. The first computer updates a setting by itself and excludes the console from the communication target.

In the switching which is based on the premise of communications between two computers as mentioned above, a console always needs to communicate with a first computer. For example, a started-up computer needs to communicate with the first computer at the time of its start-up. Therefore, when the first computer does not normally operate due to failures, and the like, the console may not only communicate with the first computer but also may not be switched with the first computer. Accordingly, a console becomes in a state in which it may not communicate with any computer. Such a state also occurs when the first computer does not normally operate during communications. The occurrence of such a state means that the operator may not manage other computers which normally operate, by consoles.

It is possible that a computer does not continuously operate normally. Failures which occur to a computer or cut-offs of a power supply to a computer (a power supply stop) and the like make the normal operation of a computer impossible. Such failures or cut-offs of a power supply and the like are events to be assumed. From this, enabling continuation of restriction to the number of computers which communicate with a console simultaneously is important even when no computer operates normally.
Patent Document 1: Japanese Laid-open Patent Publication No. 11-259322
Patent Document 2: Japanese Laid-open Patent Publication No. 5-120247

### SUMMARY

According to an aspect of the embodiments, a method for establishing a communication between a plurality of computers and a data processing device through a network, the method includes reporting, when a change occurs in a communication state between the plurality of computers and the data processing device, the change in the communication state to another computer, recognizing, from among the plurality of computers, a computer which establishes a communication with the data processing device, based on a notice of the change in the communication state, and establishing, when a number of computers for which each of the plurality of computers recognizes to have established a communication with the data processing device is not greater than a predetermined prescribed number, a communication with the data processing device, with a request from the data processing device.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 illustrates a configuration example of a computer system according to the present embodiment.

FIG. 2 illustrates a configuration example of a cluster which is a computer according to the present embodiment.

FIG. 3 illustrates a configuration example of an HW (HardWare) console.

FIGS. 4A and AB illustrate a method for restricting a cluster which establishes communications with each HW console.

FIG. 5 illustrates a content example of a cluster configuration table.

FIG. 6 illustrates a transition of a communication state of each cluster.

FIG. 7 illustrates a flowchart which indicates a process flow related to a connection with an HW console executed by a started-up cluster.

FIG. 8 illustrates a flowchart of a process executed when a power of an HW console is supplied.

FIG. 9 illustrates a flowchart of connection request processing.

FIGS. 10A and 10B illustrate a flowchart which indicates a process flow related to a connection with an HW console executed by a cluster which cuts off a power.

FIG. 11 illustrates a flowchart of console connection processing.

FIGS. 12A and 12B illustrate a flowchart of connection path switching processing.

FIG. 13 illustrates a flowchart of console monitoring processing.

FIG. 14 illustrates a flowchart of console connection path monitoring processing.

FIGS. 15A and 15B illustrate a flowchart of alarm message output processing.

### DESCRIPTION OF EMBODIMENTS

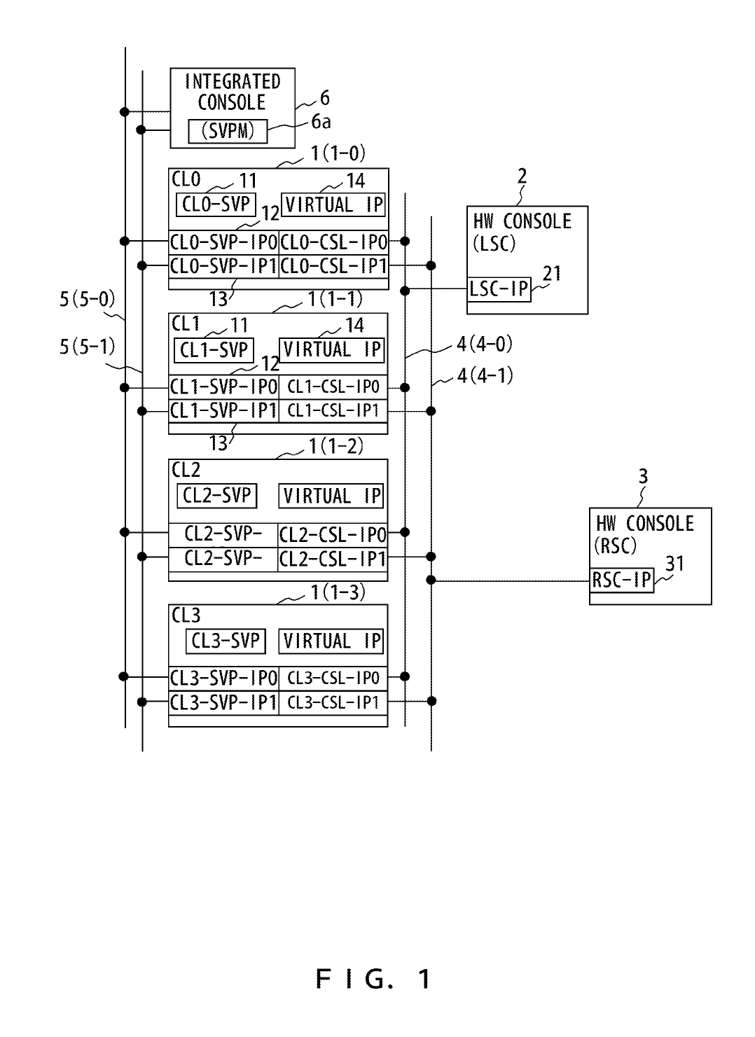

Hereinafter, a detailed explanation is described for the embodiments, in reference to the drawings. FIG. 1 illustrates a configuration example of a computer system according to the present embodiment. As illustrated in FIG. 1, a computer system includes a plurality of computers (hereafter indicated as “a cluster”) 1 (1-0 to 1-3) which are used as servers, two HW (HardWare) consoles 2 and 3, and an integrated console 6. The integrated console 6 and each cluster 1 are connected, for example, to two LANs (Local Area Networks) 5 (5-0 and 5-1). HW consoles 2 and 3 and each cluster 1 are connected to, for example, two LANs 4 (4-0 and 4-1). Both HW consoles 2 and 3 correspond to data processing devices in a computer system according to the present embodiment.

An integrated console 6 is a console for managing an entire computer system (which includes operations). A management function of the integrated console 6 is provided by an SVPM (SerVice Processor Manager) 6a mounted on the integrated console 6. For a fault tolerance, the integrated console 6 and each cluster 1 are connected to two LANs 5. For data communications between clusters 1, LAN 5 is used.

An HW console 2 is, for example, an LSC (Local System Console) that is installed in a room in which each cluster 1 is installed. An HW console 3 is an RSC (Remote System Console) that is installed in a location which is not a room in which each cluster 1 is installed. Both HW consoles 2 and 3 are consoles for managing (maintaining) each cluster 1. The HW console 2 and each cluster 1 may perform communications through a LAN 4-0, and an HW console 3 and each cluster 1 may perform communications through a LAN 4-1. With this, each cluster 1 is enabled to be managed even when a failure occurs in either one of HW consoles 2 and 3, or one of LANs 4-0 and 4-1.

The HW consoles 2 and 3 respectively include LAN interfaces 21 and 31 which allow communications through the LAN 4. An “LSC-IP” and an “RSC-IP” illustrated in FIG. 1 respectively illustrate IP (Internet Protocol) addresses for performing communications though the LAN interfaces 21 and 31.

Each cluster 1 corresponds to a computer according to the present embodiment and includes an SVP (SerVice Processor) 11 and two SCAs (SVP Communication Adapters) 12 and 13. The SVP 11 is a processing device which allows for a management of a cluster 1 using each of the HW consoles 2 and 3. The SVP 11 of each cluster 1 uses a virtual IP address 14 for communications between each of HW consoles 2 and 3. Each of the SCAs 12 and 13 includes two LAN interfaces to allow for communications through LANs 4 and 5.

The SCA 12 allows for communications through LANs 5-0 and 4-0 by two LAN interfaces. The SCA 13 allows for communications through LANs 5-1 and 4-1 by two LAN interfaces. In a cluster 1-0, a “CL0-SVP-IP0” and a “CL0-CSL-IP0” illustrated in the SCA 12 respectively indicate IP addresses of the SCA 12 for performing communications through LANs 5-0 and 4-0. A “CL0-SVP-IP1” and a “CL0-CSL-IP1” illustrated in the SCA 13 respectively indicate IP addresses of the SCA 13 for performing communications through LANs 5-1 and 4-1. The same applies to other clusters 1-1 to 1-3.

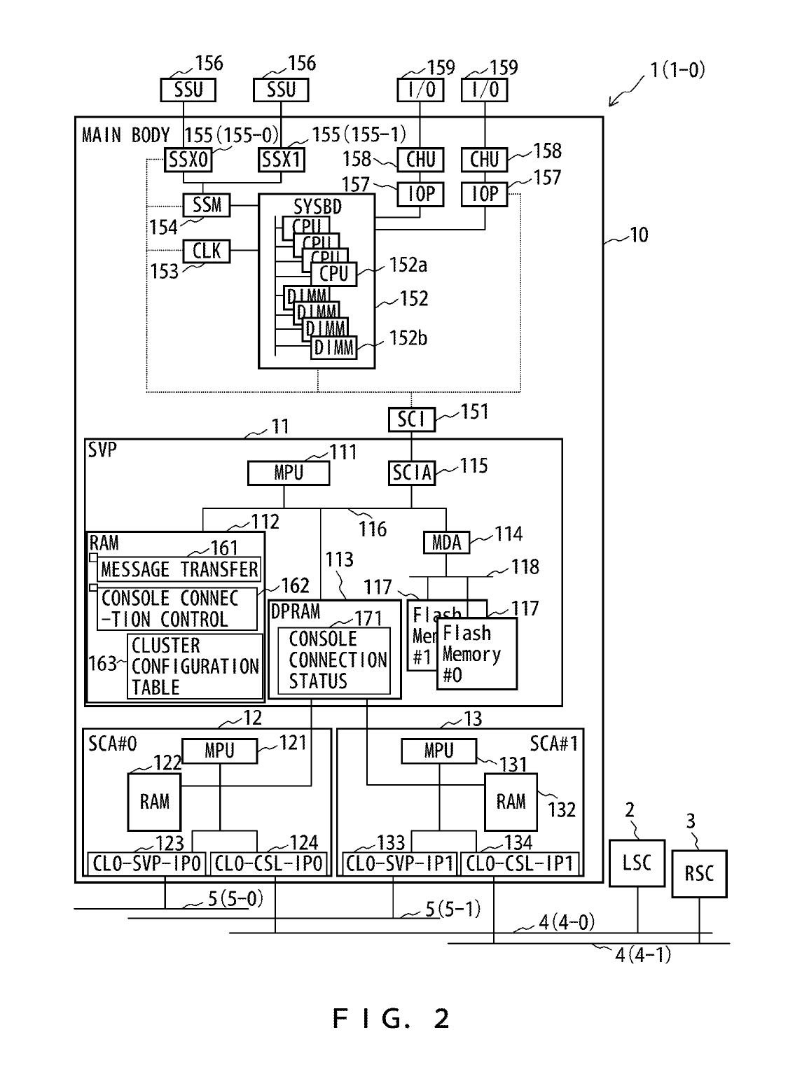

FIG. 2 illustrates a configuration example of a cluster according to the present embodiment. As illustrated in FIG. 2, a cluster 1 has a configuration in which two SSUs (System Storage Units) 156 and two input/output devices (illustrated as “I/O” in FIG. 2) are connected to a main body 10. A system body (illustrated as “SYSBD” in FIG. 2) 152 is mounted on the main body 10 in addition to the SVP 11 and two SCAs 12 and 13.

A system board 152 includes a plurality of CPUs (Central Processing Units) 152a and a plurality of memory modules (illustrated as “DIMM” in FIG. 2. DIMM is an abbreviation for Dual Inline Memory Module) 152b and functions as a computer. Although only one system board is illustrated in FIG. 2, typically, a plurality of system boards 152 is mounted on a cluster 1.

A clock is supplied from a clock generator 153 to the system board 152. The system board 152 accesses two SSUs 156 through SSXs (System Storage Extenders) 155 (155-0, 155-1) and an SSM (System Storage Mover) 154. The system board 152 respectively uses a CHU (CHannel Unit) 158 of different systems and an IOP (Input/Output Processor) 157, for accessing two input/output devices 159.

The system board 152, the clock generator 153, the SSM 154, and each IOP 157 are connected to an SCI (System Console Interface) 151. The SCI 151 provides an interface for the connected SVP 11 to control them or to communicate with them.

The SVP 11 includes an MPU (Micro-Processing Unit) 111, a RAM (Random Access Memory) 112, a DPRAM (Dual Port RAM) 113, an MDA (Micro Disk Adapter) 114, an SCIA (SCI adapter) 115, and a bus 116 to which the MPU 111, the RAM 112, the DPRAM 113, the MDA 114, and the SCIA 115 are connected, a plurality of flash memories 117, and a bus 118 which connects the flash memories 117 and the MDA 114.

The SCA 12 includes an MPU 121, a RAM 122, and two LAN interfaces 123 and 124. Similarly, the SCA 13 includes an MPU 131, a RAM 132, and two LAN interfaces 133 and 134.

In the above configuration, each CPU 152a of the system board 152 makes a cluster 1 function as a server, by, for example, acquiring and executing the program stored in either of two SSUs 156. Communications between clusters 1 and communications with an HW console 2 or HW console 3 are performed through the SCA 12 or the SCA 13. Each CPU 152a is connected to the SCAs 12 and 13 and performs transmissions and receptions of data between other clusters 1 through the SCA 12 or the SCA 13.

The MPU 111 of the SVP 11 provides a function as the SVP 11 by reading the program from the flash memories 117 through the MDA 114, storing the program in the RAM 112 and executing the program, for example. As a program stored in the RAM 112, a message transfer program 161 and a console connection control program 162 are included. A message transfer program 161 is a program for realizing message transmissions through another cluster 1 to the HW console 2 or HW console 3 and for realizing message transfers received from another cluster 1 to the HW console 2 or HW console 3. A console connection control program 162 is a program to allow only one cluster 1 from among the plurality of clusters 1-0 to 1-3 to communicate with the HW console 2 or HW console 3.

The computer according to the present embodiment is realized as the MPU 111 of the SVP 11 executes at least the console connection control program 162. The console connection control program 162 (and the message transfer program 161) may be stored in a recording medium other than the flash memories 117 or may be received through the LAN 5 and the like.

The communications with another cluster 1, the HW console 2 or the HW console 3 are performed by inputting and outputting pieces of data to and from the SCA 12 or the SCA 13 through a DPRAM 113. In the DPRAM 113, a console connection status table 171 is stored. A console connection status table 171 is a table for managing communications with the HW consoles 2 and 3 by the SCAs 12 and 13. In the console connection status table 171, data (hereafter called “console connection status data”) for managing communications with the HW consoles 2 and 3 through LAN interfaces 124 and 134 of the SCAs 12 and 13 is stored. A cluster configuration table 163 stored in the RAM 112 is a table for specifying a communication state with the HW consoles 2 and 3 for each cluster 1. In the cluster configuration table 163, console connection status data of the HW consoles 2 and 3 is stored for each cluster 1.

A storage area of the DPRAM 113 is divided in accordance with intended uses, for example. More specifically, the DPRAM 113 is divided, for example, by combinations for inputting and outputting data (messages) (SVP11→SCA12, SVP11→SCA13, SCA12→SVP11, and SCA13→SVP11), data types, and the like. With this, the inputting and outputting of data are performed between the SVP11 and the SCA12 and between the SVP11 and the SCA 13, through the DPRAM 113. The console connection status table 171 is stored in the DPRAM 113. As a consequence, each of the MPUs 121 and 131 of the SCAs 12 and 13 may directly access the console connection status table 171.

For example, the MPU 121 of the SCA 12 respectively monitors the corresponding storage area of the DPRAM 113 and processes the data stored in the storage area. With the data processing, the message transmission through the LAN interface 123 or 124 is realized. Each of the interfaces 123 and 124 stores a received message in the RAM 122, for example, and reports to the MPU 121 the reception of the message. The MPU 121, when receiving a notice, reads out the message stored in the RAM 122 and stores in the corresponding storage area of the DPRAM 113. With this, the SVP 11 acquires the received message.

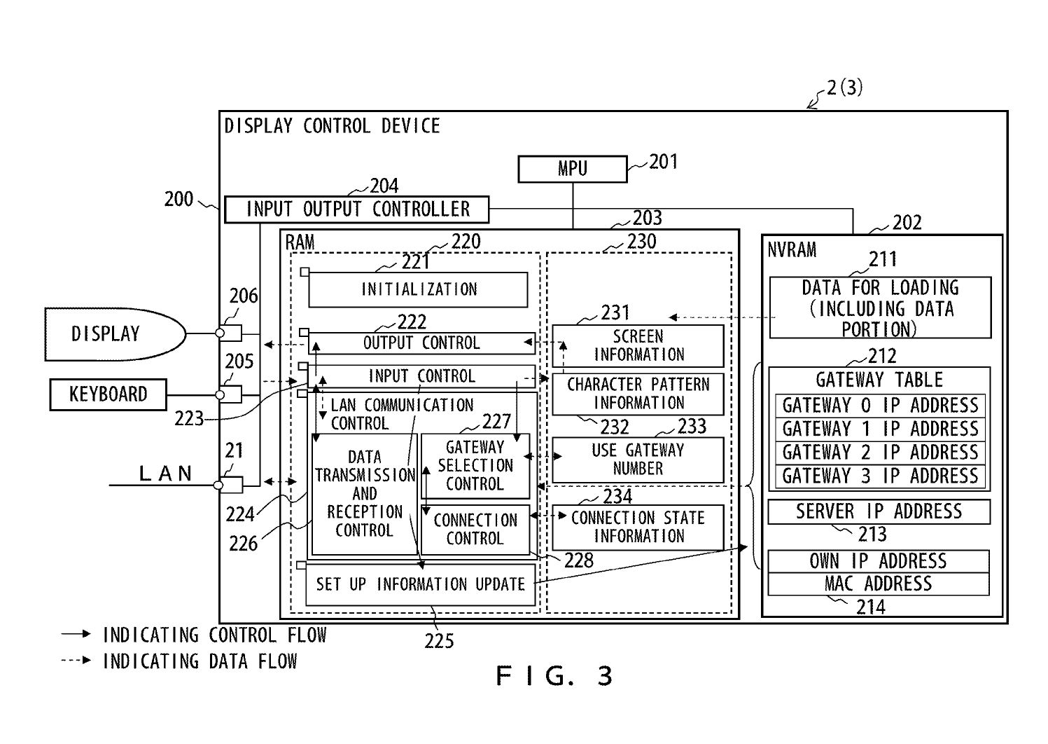

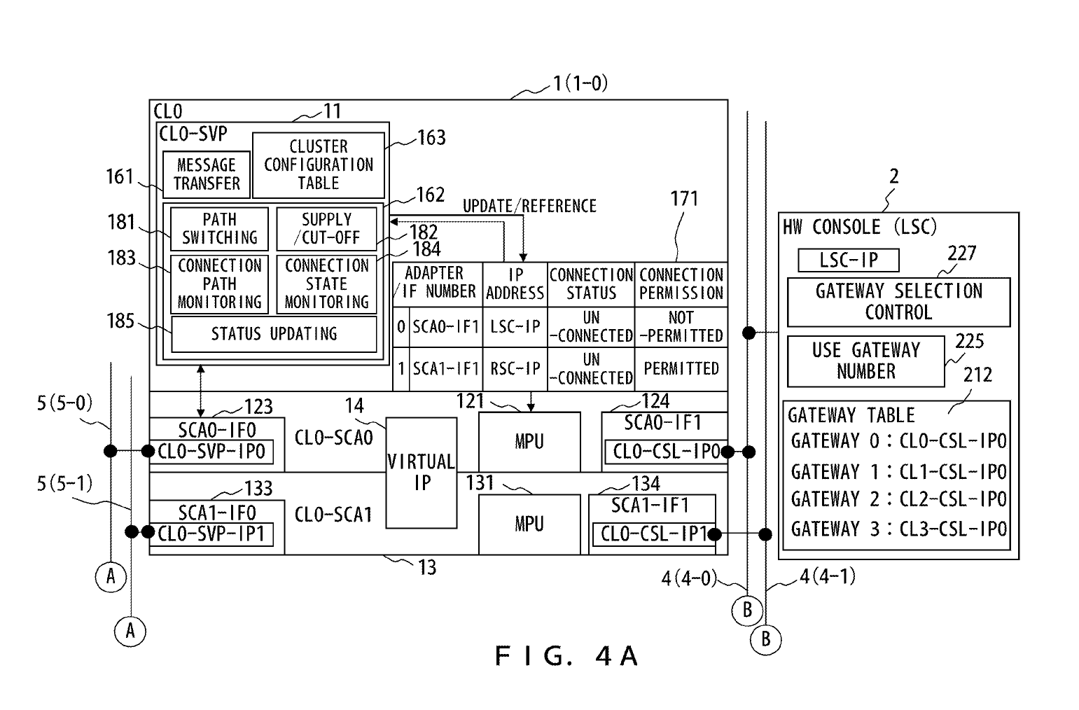

FIG. 3 illustrates a configuration example of an HW console. As illustrated in FIG. 3, the HW console 2 has a configuration in which a display 240 and a keyboard 250 are connected to a display control device 200. The display control device 200 includes an MPU 201, an NVRAM (Non Volatile RAM) 202, a RAM 203, an input/output controller 204, and a keyboard interface 205, a display interface 206, and a LAN interface 21.

In the NVRAM 202 which is a non-volatile memory, data for loading 211, a gateway table 212, a server IP address 213, and an own IP address 214 are stored. The gateway table 212, the server IP address 213, and the own IP address 214 are setup information for the HW console 2 to communicate with each cluster 1 through a LAN 4-0.

The data for loading 211 includes a control program 220 executed by the MPU 201 and a data portion 230 used for processing. The control program 220 includes an initialization program 221, an output control program 222, an input control program 223, a LAN communication control program 224, and a setup information update program 225, as sub programs. The LAN communication control program 224 includes a data transmission/reception control program 226, a gateway selection control program 227, and a connection control program 228, as sub programs.

An initialization program 221 is a program for performing initialization at a time when a power is supplied (a start-up). An output control program 222 is a program for outputting a data (screen) to a display 240. An input control program 223 is a program for inputting data to a keyboard 250 in accordance with an operation. A LAN communication control program 224 is a program for communicating with each cluster 1 through a LAN 4-0. A setup information update program 225 is a program for updating setup information stored in the NVRAM 202.

A data transmission/reception control program 226 which is a sub program of the LAN communication control program 224 is a program for transmitting and receiving data (messages) between each of the clusters 1 through the LAN interface 21 and the LAN 4-0. A gateway selection control program 227 is a program for selecting (the SCA 12 of) clusters 1 which actually perform communications from among a plurality of clusters 1. A connection control program 228 is a program for managing a communication state with clusters 1, that is, a connection control program 228 is a program for managing whether clusters 1 exist that have established communications.

A data portion 230 includes screen information 231, character pattern information 232, a use gateway number 233, and connection state information 234. Screen information 231 is information for displaying a screen on a display 240. Character pattern information 232 is information for arranging characters (character strings), symbols, and the like, to be arranged on a screen which is displayed on the display 240. A use gateway number 233 is information for managing clusters 1 which currently establishes communications and is updated by a gateway selection control program 227 of the LAN communication control program 224. Connection state information 234 is information for indicating whether clusters 1 exist that have established communications and connection state information 234 is updated by a connection control program 228 of the LAN communication control program 224.

A gateway table 212 is a table which stores an IP address allocated to the SCA 12 of each cluster 1. “Gateway 0” to “Gateway 3” illustrated in FIG. 3 respectively illustrate the number (the gateway number) allocated to each SCA 12 of clusters 1-0 to 1-3. A server IP address 213 is a virtual IP address 14 used for communicating with the SVP 11 of each cluster 1. An own IP address 214 includes an IP address allocated to an HW console 2 and a MAC (Media Access Control) address which is an ID (IDentifier) of the LAN interface 21.

When a power is supplied, the MPU 201 reads out the data for loading 211 from the NVRAM 202 and stores the data in the RAM 203, and starts executing a control program 220 of the data for loading 211. The MPU 201, after starting executing the control program 220, performs the control which corresponds to the operation by the operator on the keyboard 250 or the reception of the message by the LAN interface 21.

As the HW console 2 or 3, the data processing device of the same configuration may be used. Here, for the purpose of explanations and conveniences, the HW console 3 is assumed to have a configuration as illustrated in FIG. 3 and reference numerals that are the same as those of the HW console 2 are used for components.

A computer system according to the present embodiment is configured, using four clusters 1 and two HW consoles 2 and 3 as mentioned above. However, the configuration of the computer system is not limited to what is illustrated in FIG. 1. In addition, the configuration of the clusters 1 and the configuration of the HW consoles 2 and 3 are not limited to what are illustrated in FIG. 2 or FIG. 3.

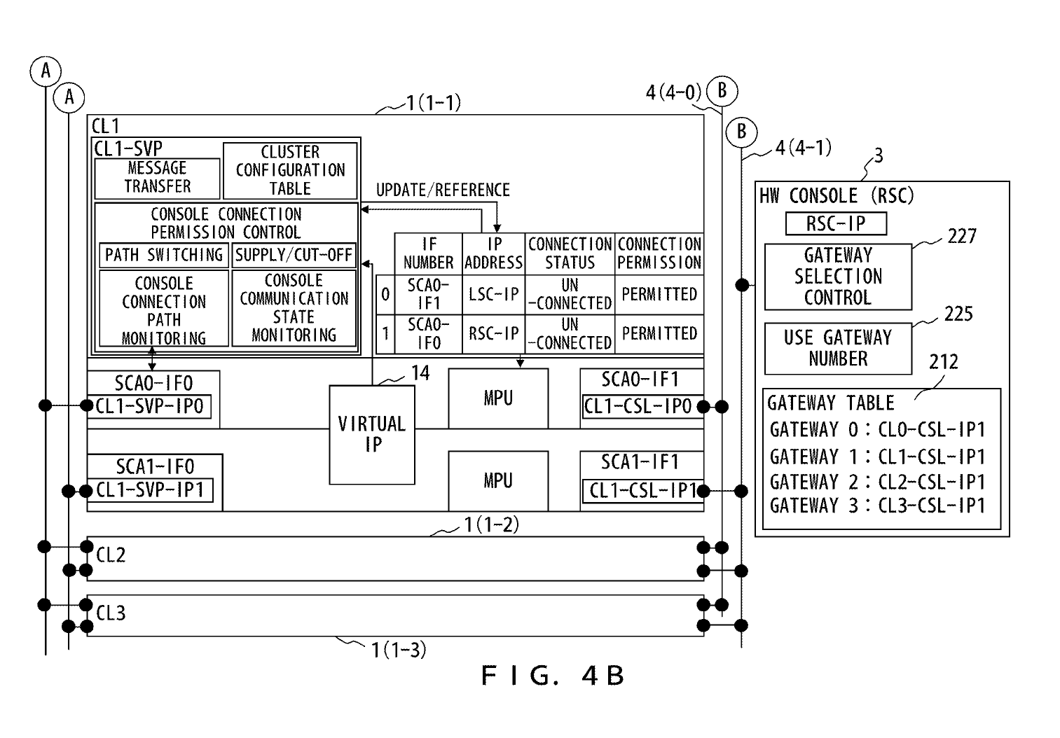

In the above mentioned computer system, as a protocol for defining communications between each HW console 2 and 3 and clusters 1, a protocol in which each HW console 2 and 3 establish communications only with one cluster simultaneously (in parallel) is employed. From this, in the present embodiment, the number of clusters 1 with which each HW console 2 and 3 may establish communications simultaneously is restricted to only one. Hereafter, detailed explanations are described for a method of realizing such restrictions in reference to FIG. 4 to FIG. 6. The number of clusters 1 with which each HW console 2 and 3 may establish communications simultaneously may be two or more, and the reason for restricting the number of clusters 1 which may establish communications simultaneously may be different from the above reason.

FIG. 4 explains a method for restricting the number of a cluster which establishes communications with each HW console. First, specific explanations are described for a method thereof in reference to FIG. 4. Since the methods are the same in the HW consoles 2 and 3, hereafter, for a certain convenience, explanations are given only for the HW console 2. Further, unless otherwise defined, “a connection” hereafter means to establish communications, that is, it means a state in which communications may be performed.

In the present embodiment, the establishment (connection) of the communications of the HW console 2 and the cluster 1 is based on the premise that it is performed by a transmission of a connection request which is a message requesting the connection from the side of the HW console 2. A selection (change) of the cluster 1 to be connected is typically performed by the operator. The output control program 222 of the control program 220 outputs the screen for the operator to select the cluster 1 on the display 240 and the cluster 1 which was selected on the screen are recognized by the input control program 223. The recognition result is reported to the LAN communication control program 224 in the form of a gateway number, for example. With this, the gateway selection control program 227 of the LAN communication control program 224 reads out an IP address of the gateway number reported from the input control program 223 from the gateway table 212, and sets the IP address as a transmission destination address of the message. The gateway number is stored by the gateway selection control program 227 as the use gateway number 233 of the data portion 230.

The report of the gateway number from the input control program 223 means that the operator has instructed the switching of the cluster 1 to be connected. From this, with the report of the gateway number, the connection control program 228 of the LAN communication control program 224 transmits a connection path switching instruction which is a message of reporting to terminate the communications with a cluster 1 and establish the communications with another cluster 1, when the currently connected cluster 1 exists. After that, the connection control program 228 transmits a connection request to the cluster 1 to which the reported gateway number is allocated. With the transmission of the connection request, the HW console 2 establishes communications with the cluster 1 selected by the operator. The actual transmissions and receptions of the messages are performed by the data transmission/reception control program 226.

The update of the use gateway number 233 by the gateway selection control program 227 is performed when the cluster 1 for which the communications are to be established is determined or when the communications with the determined cluster 1 are established. In these cases, the connection control program 228 stores a value which indicates a state of being connected to the cluster 1, as the connection state information 234. When the communication with the cluster 1 selected by the operator was not established, the gateway selection control program 227 does not update the use gateway number 233. At this time, the connection control program 228 stores the value which indicates a state of being not connected to the cluster 1, as the connection state information 234. Hereafter, the value which indicates a state of being connected to the cluster 1 is assumed to be “1” and the value which indicates a state of not being connected to the cluster 1 is assumed to be “0”.

Thus, the HW console 2 operates so as to always establish communications with only one cluster 1. Another cluster 1 autonomously operates so that only one cluster 1 may be connected to the HW console 2, even when the HW console 2 inappropriately operates. The cluster configuration table 163 and the console connection status table 171 are used for their autonomous operations.

The console connection status table 171 is used for managing the connection with the HW consoles 2 and 3 by the LAN interfaces 124 and 134 of the SCAs 12 and 13. The console connection status data includes an adapter number, an interface (IF) number, an IP address, connection status information, and connection permission information.

An adapter number is identification information respectively allotted to the SCAs 12 and 13, in which “0” indicates the SCA 12 and “1” indicates the SCA 13, respectively. An interface number is identification information respectively allotted to two LAN interfaces provided by the SCAs 12 and 13, in which “0” indicates the LAN interfaces 123 and 133 and “1” indicates the LAN interfaces 124 and 134, respectively. An IP address is used as identification information which indicates a target for which a plurality of clusters restricts connections. The “LSC-IP” and “RSC-IP” illustrated in FIG. 4 respectively indicate the IP address of the HW consoles 2 and 3. Connection status information is information which indicates whether a connection is made to the HW console 2 (or 3), wherein “0” indicates an unconnected situation and “1” indicates a connected situation, respectively. Connection permission information is information which indicates whether a connection is permitted to the HW console 2 (or 3), wherein “0” indicates non-permission for a connection, and “1” indicates permission for a connection, respectively.

A communication state of the cluster 1 with the HW console 2 is managed by the above mentioned connection status information and connection permission information. Both connection status information and connection permission information are binary information of “0” or “1”. Accordingly, the number of combinations indicated by the connection status information and connection permission information is four. However, in the status of being connected to the HW console 2, whether the connection to the HW console is permitted has no meaning. From this, the number of combinations indicated by the connection status information and connection permission information becomes three, actually. The three specific combinations consist of a combination of connection status information=1 and connection permission information=0, a combination of connection status information=0 and connection permission information=1, and a combination of connection status information=0 and connection permission information=0.

The combination of connection status information=1 and connection permission information=0 indicates the state of being connected to the HW console 2 (hereafter called “a connected state”). Although the combination of connection status information=0 and connection permission information=1 is not connected to the HW console 2, it indicates a state in which the connection to the HW console 2 is available (hereafter called “a connection stand-by state”). The combination of connection status information=0 and connection permission information=0 indicates the state in which the connection to the HW console 2 is not permitted (hereafter called “a connection not-permitted state”). In each cluster, a not-started up state (hereafter called “a stop state”) exists. The number of communication states for each cluster 1 is four in total, when including the stop state.

FIGS. 4A and 4B illustrate (0, 1, LSC-IP, unconnected, not-permitted) and (1, 1, RSC-IP, unconnected, permitted) as console connection status data stored in the console connection status table 171. From what was mentioned above, (0, 1, LSC-IP, unconnected, not-permitted) illustrates that the target for the communication which uses the LAN interface 124 of the SCA 12 is the HW console 2, and that a communication state is a connection not-permitted state. (1, 1, RSC-IP, unconnected, permitted) illustrates that the target for the communication which uses the LAN interface 134 of the SCA 13 is the HW console 3, and that a communication state is a connection permitted state.

Thus, a console connection status data is a piece of data which indicates the communication state with an assumed communication target. The console connection status data are used for recognizing the communication state of the other cluster 1 in addition to managing the communication state of the own cluster 1. A cluster configuration table 163 is used for recognizing the communication state of another cluster 1.

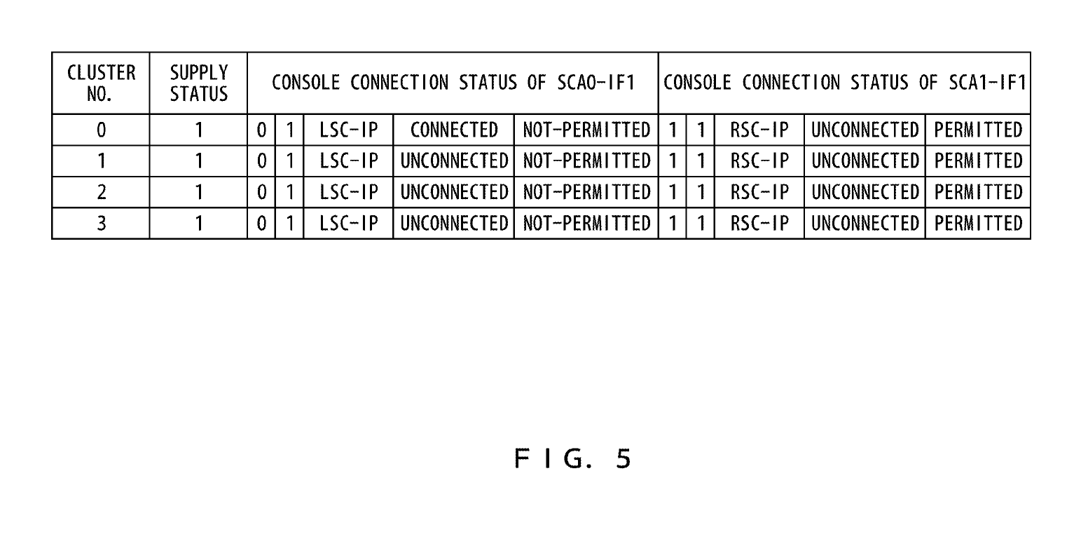

FIG. 5 illustrates a content example of a cluster configuration table. As mentioned above, in the cluster configuration table 163, two console connection status data of each cluster 1 are stored. The two console connection status data are stored in the cluster configuration table 163 such that the two console connection status data are integrated in one record (entry) for each cluster 1, as illustrated in FIG. 5. In FIG. 5, the console connection status data

for the LAN interface 124 of the SCA 12 is illustrated as “console connection status of SCA0-IF1”. The console connection status data for the LAN interface 134 of the SCA 13 is illustrated as “console connection status of SCA1-IF1”.

In each record, in addition to the two console connection status data, a cluster number and supply status information are stored. A cluster number is identification information which is allocated to each cluster 1. The cluster number matches up, for example, with the gateway number. Supply status information is information which indicates whether a power is supplied to a corresponding cluster 1, and “0” indicates that no power is supplied, and “1” indicates that a power is supplied (currently operating), respectively. With this, whether each cluster 1 is in a stop state may be determined by supply status information.

Console connection status data for the LAN interface 124 of the SCA 13 for each cluster 1 indicates that only one cluster 1 (here, it is the cluster 1-0) is in a connected state and that all the other clusters 1-1 to 1-3 are in a connection not-permitted state. With this, all the other clusters 1 may not be connected to the HW console 2 in a state in which one cluster 1 is in a connected state.

On the other hand, console connection status data for the LAN interface 134 of the SCA 13 for each cluster 1 indicates that all the clusters 1 are in a connection permitted state. With this, in a situation in which no cluster 1 in a connected state exists, all of each cluster 1 may be connected to the HW console 2. In such a situation, when one cluster 1 is shifted to a connected state, all the other clusters 1 are shifted to a connection not-permitted state. When the cluster 1-0 is shifted to a connected state, a communication state of each cluster 1 becomes the one that is indicated by the console connection status data for the LAN interface 124 of the SCA 12 of each cluster 1.

Thus, for each cluster 1, information for recognizing the communication state is stored in the cluster configuration table 163. Accordingly, by referring to the cluster configuration table 163, each cluster may recognize the communication state of the other clusters 1. Therefore, the restriction to make only one cluster 1 be connected to the HW console 2 may be realized by referring to the cluster configuration table 163, as well as the restriction to make predetermined some clusters 1 be connected to the HW console 2 may be realized by referring to the cluster configuration table 163.

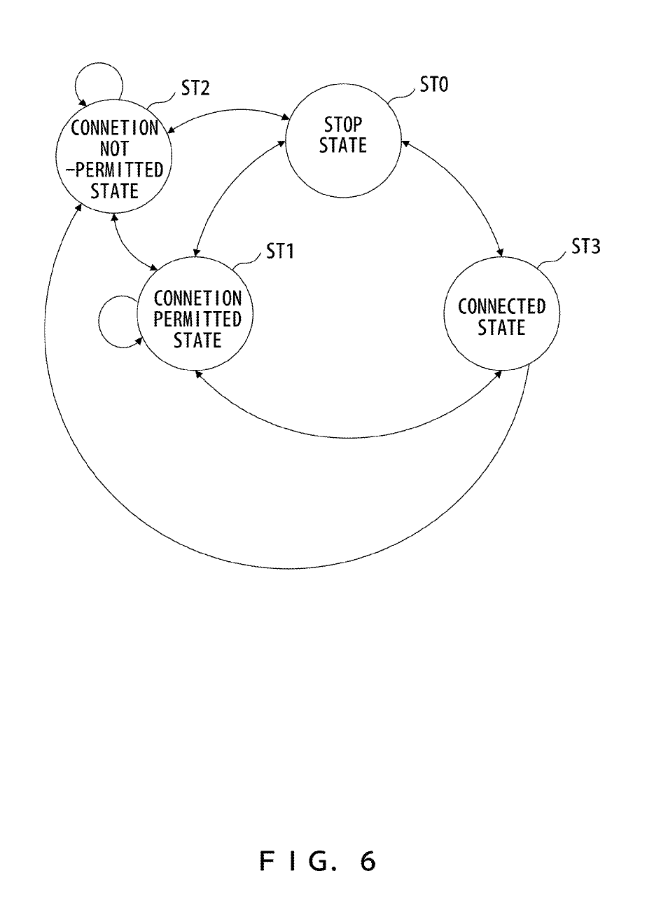

FIG. 6 illustrates a transition of a communication state of each cluster. As a communication state, four types that are a stop state ST0, a connection permitted state ST1, a connection not-permitted state ST2, and a connected state ST3 exist, as mentioned above. Each cluster 1 before the start-up is in a stop state ST0, and by starting it up, each cluster 1 acquires two types of console connection status data for the other clusters 1 and is shifted to the connection permitted state ST1 or the connection not-permitted state ST2. More specifically, the started-up cluster 1 is shifted to the connection permitted state ST1 when no cluster 1 in a connected state ST3 exists, and the started-up cluster 1 is shifted to the connection not-permitted state ST2 when a cluster 1 in a connected state ST3 exists.

The cluster 1 shifted to the connected state ST3 so reports to the other clusters 1. The cluster 1 shifted to the connected state ST3, when it terminates the connection, so reports to the other clusters 1 and is shifted to the connection permitted state ST1 or the connection not-permitted state ST2. From this, each cluster 1 recognizes the existence of the cluster 1 in the connected state ST3 from among the other clusters 1. The cluster 1 in the connected state ST3 is also illustrated as “a first cluster” hereafter. The shift from the connected state ST3 to the connection not-permitted state ST2 is performed when the above connection path switching indication is received, that is, when the cluster 1 to which the HW console 2 is connected is switched.

Each cluster 1, when it recognizes the shift to the connected state ST3 of the other cluster 1, makes the other cluster 1 shift to the connection not-permitted state ST2. The connection not-permitted state ST2 is maintained until it is confirmed that a first cluster 1 which is the cluster 1 in the connected state ST3 no longer exists. Accordingly, the number of the first cluster 1 which may exist simultaneously becomes only one.

Each cluster 1 which recognizes the shift of the other cluster 1 from the connected state ST3 to the connection permitted state ST1 makes the connection state shift from the connection not-permitted state ST2 to the connection permitted state ST1. Accordingly, any of a plurality of clusters 1 may establish communications with the HW console 2. With this, the operator may connect the HW console 2 to the desired cluster 1.

Each cluster 1 is shifted to the stop state ST0 from any of the connection permitted state ST1, the connection not-permitted state ST2, and the connected state ST3 due to the instruction to cut off the power supply, failures, or the like. With this, in the present embodiment, each cluster 1 carries out a state transition as illustrated in FIG. 6.

As each cluster 1 carries out the state transition as illustrated in FIG. 6, recognizing the communication state of the other cluster 1, the number of the cluster 1 which may establish communications simultaneously with the HW console 2 in each cluster 1 is restricted to only one. When one cluster 1 is shifted to the connected state ST3, the one cluster 1 which is not the cluster 1 of the first cluster 1 monitors the other clusters 1 which include the first cluster 1, confirms the cluster 1 which does not normally operate, and reflects a confirmation result on the state transition. With this, in the situation where there is no cluster 1 in the connected state ST3 and where there is no cluster 1 in the connection permitted state ST1, all the other clusters 1 during operations are shifted to the connection permitted state ST1 thereby allowing them to be connected to the HW console 2. Accordingly, the operator may connect the HW console 2 to the other arbitrary clusters 1 even when the first cluster 1 does not normally operate due to a cut-off of the power supply, an occurrence of failures, or the like.

The above mentioned state transition is realized as the MPU 111 of the SVP 11 of each cluster 1 executes a console connection control program 162. The console connection control program 162 includes a path switching program 181, a supply/cut-off program 182, a console connection path monitoring program 183, a console communication state monitoring program 184, and a status update program 185, as sub programs.

A path switching program 181 is a program for performing or completing a connection to the HW console 2. A supply/cut-off program 182 is a program for responding to a power supply and a power cut-off (disconnection) of a cluster 1. A console connection path monitoring program 183 is a program for monitoring whether the other first cluster 1 normally operates. A console communication state monitoring program 184 is a program for monitoring whether a communication with the HW console 2 may be performed, that is, whether the HW console 2 normally operates, when the own cluster 1 is connected to the HW console 2. A status update program 185 is a program for updating a console connection status data of the cluster configuration table 163 and of the console connection status table 171.

The SVP 11 which executes the above mentioned path switching program 181 reports, to the other cluster 1, a transition of a communication state by a shift from a connection permitted state ST1 to a connected state ST3, and from a connected state ST3 to a connection permitted state. Such a notice is processed by the SVP 11 as it executes the status update program 185, and console connection status data of the cluster configuration table 163 and of the console connection status table 171 are updated. The SVP 11 which executes the path switching program 181 refers to the cluster configuration table 163 and performs a shift from a connection permitted state ST1 to a connected state ST3, that is, establishes communications with the HW console 2.

From this, a recognition of the other cluster 1 being connected to the HW console 2 is performed by executing at least the path switching program 181 and the status update program 185. A management to make only a predetermined number (here, it is one) of the cluster 1 be connected to the HW console 2 is realized as the SVP 11 executes the path switching program 181.

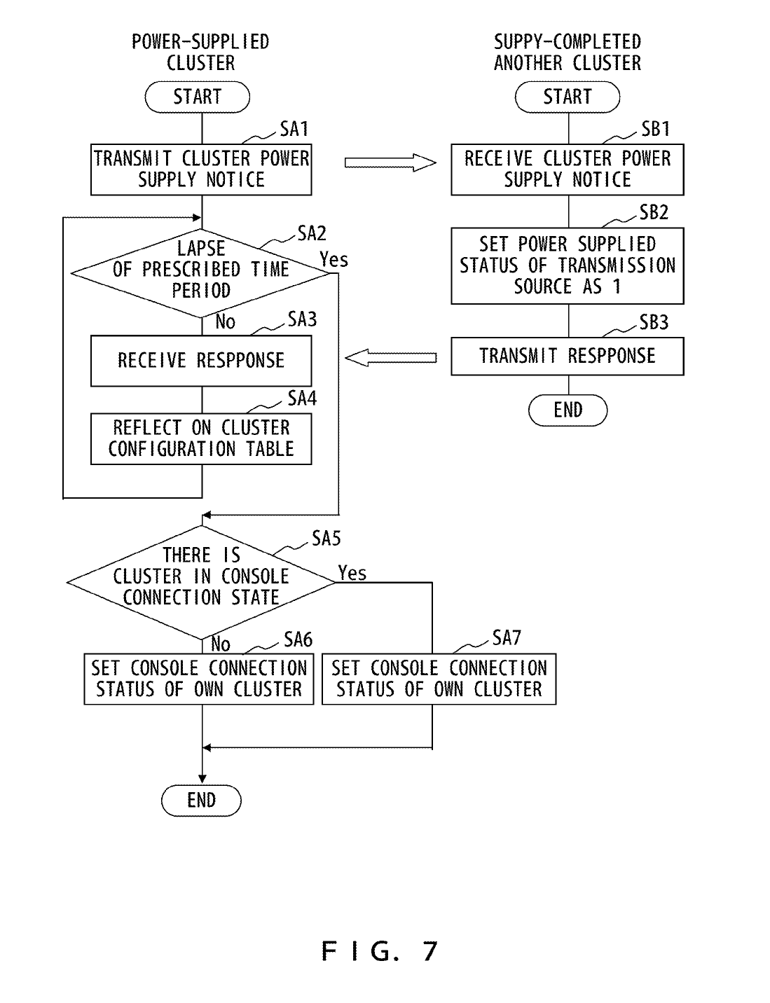

Hereafter, detailed explanations are described for each operation of the cluster 1 and the HW console 2, in reference to a flow chart of each processing illustrated in FIG. 7 to FIG. 15. The operation of the cluster 1 is performed by noting the SVP 11, that is, by noting the message transfer program 161 or the console connection control program 162. The operation of the HW console 2 is performed by noting the control program 220. With this, operation explanations are performed by noting portions related to connecting the HW console 2 to the cluster 1. As mentioned above, the message transfer program 161 and the console connection control program 162 are read from the flash memory 117 to the RAM 112, for example, and are executed by the MPU 111 of the SVP 11. The control program 220 is read from the NVRAM 202 to the RAM 203 and is executed by the MPU 201.

FIG. 7 illustrates a flowchart which indicates a process flow related to a connection with an HW console executed by a started-up cluster. In FIG. 7, a flowchart of a processing executed by another cluster (indicated as “supply-completed another cluster” in FIG. 7) which has completed a start-up, that is, currently operating another cluster is also illustrated, in addition to a started-up cluster (indicated as “power-supplied cluster” in FIG. 7). In reference to FIG. 7, first, detailed explanations are described for processing which is related to the connection with the HW console 2 executed by each of the started-up clusters 1 and currently operating another cluster 1, when one cluster 1 is started up.

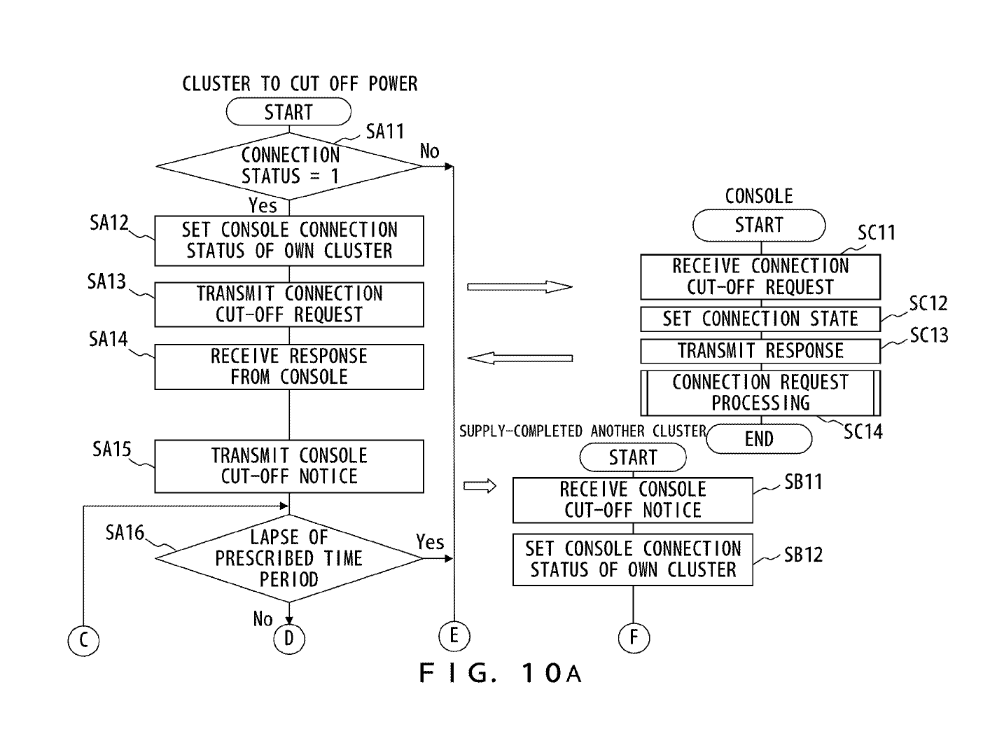

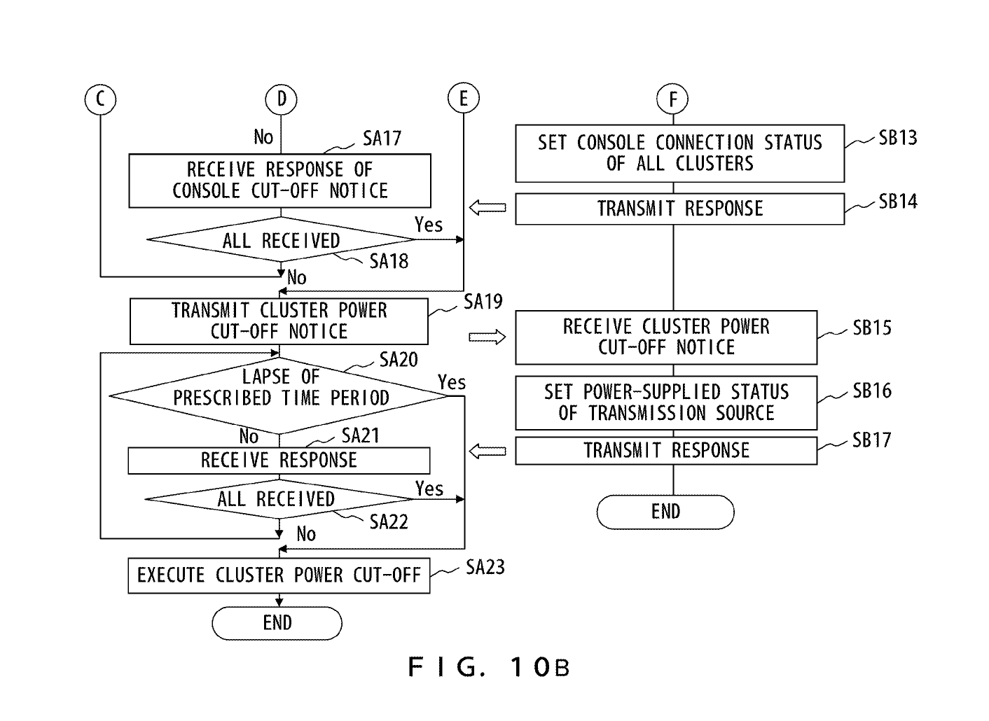

Here, for the purpose of explanations and conveniences, a cluster 1-0 is assumed as a starting-up cluster 1, and a cluster 1-1 is assumed as a supply-completed another cluster. The processing of the SVP 11 of a cluster 1-0 illustrated in FIG. 7 is mainly realized by a supply/cut-off program 182. The processing of the SVP 11 of a cluster 1-1 is realized mainly by the status update program 185. In FIG. 7, arrowheads arranged between processing steps executed by different clusters 1 indicate directions to which messages are transmitted and from which messages are received. The same applies to FIGS. 10A and 10B to FIG. 15, as well. Instructions for a power supply, a power cut-off, and the like, may be performed from the HW console 2 and the integrated console 6.

The SVP 11 of the started-up cluster 1-0 transmits to the other clusters 1-1 to 1-3 a cluster power supply notice that is a message for reporting that a power has been supplied by using the LAN interface 123 of the SCA 12 (SA1). The cluster power supply notice is transmitted targeting for all the clusters 1 the number of which are stored in the cluster configuration table 163.

The cluster power supply notice is received by the LAN interface 123 of the SCA 12 in the supply-completed another cluster 1-1 (SB1). The received cluster power supply notice is output from the SCA 12 to the SVP 11, and the SVP 11 updates supply status information of a corresponding record of the cluster configuration table 163. The update is performed by storing “1” as a value of the supply status information, as mentioned above (SB2). Subsequently, the SVP 11 transmits to the cluster 1-0 a response to the cluster power supply notice (SB3). Two types of console connection status data stored in the console connection status table 171 are transmitted to the cluster 1-0 in addition to the response. A series of processing by receiving the cluster power supply notice of the SVP 11 of the cluster 1-1 is completed by transmitting the response.

The SVP 11 of the cluster 1-0 which has transmitted the cluster power supply notice to each cluster 1-1 to 1-3 repeatedly executes processing for responding to a reception of the response from when the cluster power supply notice is transmitted until a prescribed time period passes (SA2 to SA4). More specifically, the SVP 11 determines whether the prescribed time period has passed in SA 2. When the prescribed time period has not passed, a determination of SA2 becomes No, and the SVP 11 subsequently acquires a received response from the SCA 12 (SA3), and reflects console connection status data added to the response on the cluster configuration table 163 (SA4). After the reflection, the SVP 11 is shifted to SA2 and again, the SVP 11 determines whether the prescribed time period has passed. When the prescribed time period has passed, a determination of SA2 becomes Yes, and the SVP 11 is shifted to SA5.

Right after a start-up, the value of supply status information of each record of the cluster configuration table 163 is “0”, and the console connection status data is not stored. The SVP 11 of the cluster 1-0 stores the two types of console connection status data that were added to the response in the corresponding record on the cluster configuration table 163 of the cluster 1-1 which has received the response. The value of the supply status information of the record is updated as “1”. Thus, for each received response, the record corresponding to the response of the cluster configuration table 163 is updated. The value of the supply status information of the record which does not receive any response remains “0”. With this, the started-up cluster 1-0 confirms a communication state of all the currently operating clusters 1 from among the other clusters 1-1 to 1-3 by transmitting the cluster power supply notice to each cluster 1-1 to 1-3.

In SA5, the SVP 11 refers to the cluster configuration table 163 and determines whether a cluster 1 in a connected state ST3 exists. When there is any piece of data which indicates the connected state ST3 in the console connection status of the HW console 2 stored in the cluster configuration table 163, a determination becomes Yes. In this case, the SVP 11 generates console connection status data setting the communication state of the own cluster 1-0 as the connection not-permitted state ST2, and stores the generated status data in console connection status table 171 and the cluster configuration table 163, respectively (SA7).

On the other hand, when there is no piece of data which indicates the connected state ST3 in the console connection status of the HW console 2 stored in the cluster configuration table 163, a determination of SA 5 becomes No. In this case, the SVP 11 generates console connection status data setting the communication state of the own cluster 1-0 as the connection permitted state ST1, and stores the generated status data in the console connection status table 171 and the cluster configuration table 163, respectively (SA6).

A series of processing for responding to the start-up by the SVP 11 of the cluster 1-0 are terminated by storing the console connection status data. Hereafter, the SVP 11 updates the cluster configuration table 163 or the console connection status table 171, as required.

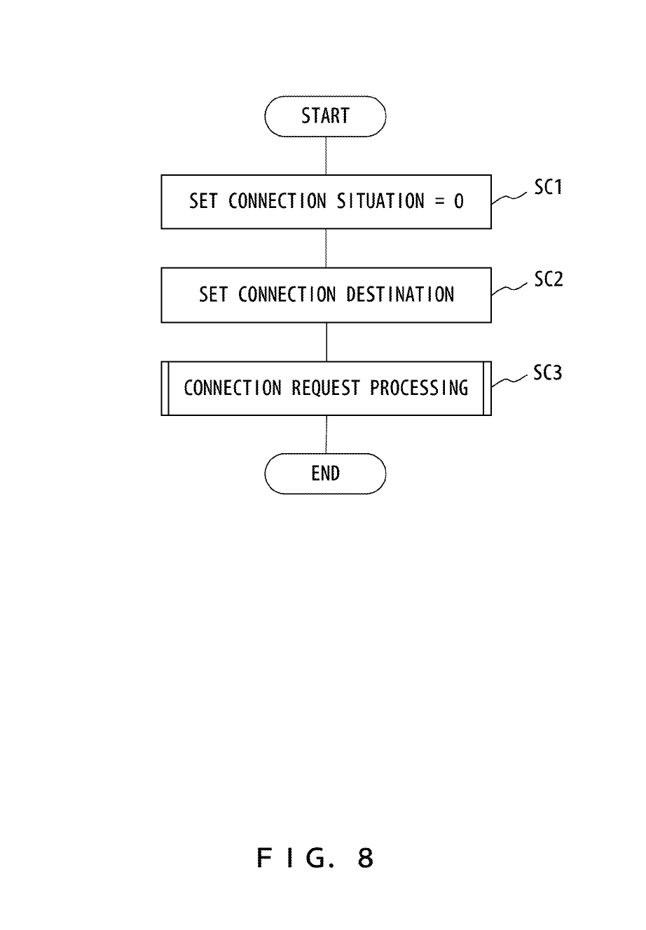

FIG. 8 illustrates a flowchart of processing executed when a power of the HW console is supplied. Next, in reference to FIG. 8, detailed explanations are described for processing to be executed for connecting to the cluster 1 at the time of power supply of the HW console 2, that is, at the time of the start-up. The processing illustrated in FIG. 8 is realized mainly by the initialization program 221 of the control program 220 and the LAN communication control program 224.

First, the HW console 2 stores “0” which is the value indicating the state of being not connected to the cluster 1, as connection state information 234 (SC1). Subsequently, the HW console 2 refers to the gateway table 212 and sets (stores) the gateway number stored in the first entry (record) as a use gate way number 233 (SC2). Then, the HW console 2 executes connection request processing (SC3). By executing the connection request processing, the HW console 2 completes a series of processing related to the connection with the cluster 1 at the time of the start-up.

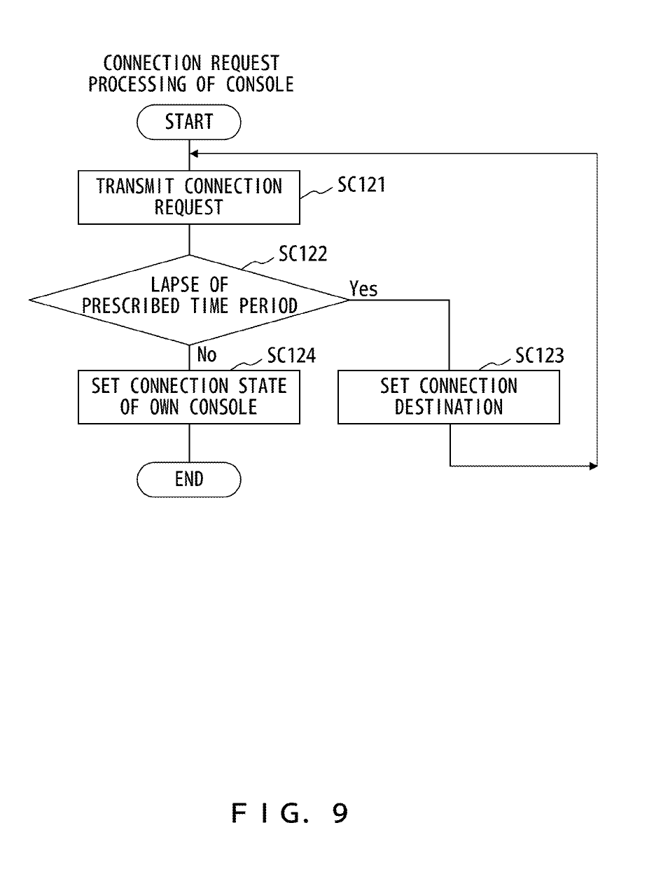

In the present embodiment, at the time of starting up the HW console 2, a connection with any of the clusters 1 is intended. Connection request processing executed in SC3 is processing for specifying a connectable cluster 1 and connecting with the specified cluster 1. The setting of the use gateway number 233 in SC2 is performed as an initial setting for executing connection request processing. Next, in reference to FIG. 9, detailed explanations are described for the connection request processing. FIG. 9 illustrates a flowchart of the connection request processing.

First, the HW console 2 reads out the use gateway number 233 and transmits to the LAN interface 21 a connection request which is a message requesting the communication establishment by setting the IP address to which the use gateway number 233 is allocated as a transmission destination (SC 121). Next, the HW console 2, after transmitting the connection request, determines whether the prescribed time period has passed before receiving the response (SC 122). When the response is received before a lapse of the prescribed time period, a determination of the SC 122 becomes No. In such a case, the HW console 2 updates the value of the connection state information 234 (SC 124). After that, the connection request processing is completed.

On the other hand, when the response is not received before a lapse of the prescribed time period, a determination of the SC 122 becomes Yes. In such a case, the HW console 2 updates the use gateway number 233 to the gateway number of the subsequent entry of the gateway table 212 (SC 123). After setting the cluster 1 to be set as the connection destination as mentioned above, a step returns to the above SC 121.

By executing the above connection request processing, the HW console 2 transmits the connection request while changing the cluster 1 which is set as the connection destination until the HW console 2 is connected to the cluster 1. With this, the HW console 2 performs connections with the connectable cluster 1 at the time of the start-up.

FIGS. 10A and 10B illustrate a flowchart which indicates a process flow related to a connection with the HW console executed by the cluster which cuts off a power. The processing is executed upon receiving the instruction from the HW console 2 or the integrated console 6 to cut off the power. In FIGS. 10A and 10B, in addition to a flowchart of the processing executed by the cluster to cut off the power (indicated as “cluster to cut off power” in FIG. 10A), the flowchart of the processing executed by supply-completed another cluster (indicated as “supply-completed another cluster” in FIG. 10A) and the HW console 2 are illustrated. Subsequently, in reference to FIGS. 10A and 10B, detailed explanations are described for processing executed by the cluster 1 to cut off the power, supply-completed another cluster 1, and the HW console 2, respectively, when a cluster 1 cuts off the power.

Here, for the purpose of explanations and conveniences, the cluster 1-0 is assumed as a cluster 1 to cut off the power, and the cluster 1-1 is assumed as supply-completed another cluster. The processing of the SVP 11 of the cluster 1-0 illustrated in FIGS. 10A and 10B is realized mainly by the supply/cut-off program 182. The processing of the SVP 11 of the cluster 1-1 is realized mainly by the status update program 185.

First, the SVP 11 of the cluster 1-0 to which the power cut-off has been instructed from the HW console 2 or the integrated console 6 refers to the console connection status data of the own cluster 1-0 and determines whether the value of connection status information is 1 (SA 11). When the communication with the HW console 2 is established, the value of connection status information becomes “1”. Therefore, when the communication with the HW console 2 is established, a determination of SA 11 becomes Yes and is shifted to SA 12. On the other hand, when the communication with the HW console 2 is not established, a determination of SA 11 becomes No and is shifted to SA 19. Console connection status data of the own cluster 1-0 is a console connection status data which is stored in the console connection status table 171.

In SA 12, the SVP 11 sets each value of the connection status information and connection permission information in the console connection status data of the own cluster 1-0 as both “0”. Subsequently, the SVP 11 causes the SCA 12 to transmit a connection cut-off request which is a message for requesting the completion of the communication to the HW console 2 (SA 13).

The HW console 2 receives a connection cut-off request which was transmitted from the cluster 1-0 (SC 11). The HW console 2 which has received the connection cut-off request sets the value of the connection state information 234 of the own console 2 as “0” (SC 12), and transmits the response to the cluster 1-0 (SC 13). Subsequently the HW console 2 executes the above mentioned connection request processing (SC 14). By executing the connection request processing, the HW console 2 terminates a series of processing by receiving the connection cut-off request.

The SVP 11 of the cluster 1-0, after transmitting the connection cut-off request, waits for receiving the response to the connection cut-off request from the HW console 2 (SA 14). When the SVP 11 receives the response, the SVP 11 transmits a console cut-off notice which is a message indicating that the communication with the HW console 2 is completed to all the clusters to which the power supply on the cluster configuration table 163 is indicated (SA 15).

The SVP 11 of the cluster 1-1 receives the received console cut-off notice through the SCA 12 (SB 11). When transmitting the console cut-off notice, all the other supply-completed clusters 1 are in the connection not-permitted state ST2. From this, the SVP 11 sets each value of connection status information and connection permission information in the console connection status data on the console connection status table 171 as “0” and “1” and make them shifted to the connection permitted state ST1 (SB 12). Subsequently, the SVP 11 sets each value of connection status information and connection permission information in the console connection status data of all the clusters 1 as “0” and “1” (SB 13). Then, the SVP 11 causes the cluster 1-0 to transmit the response (SB 14).

The SVP 11 of the cluster 1-0 after transmitting the console cut-off notice, executes processing for responding to the response to be received until the prescribed time lapses (SA 16 to SA 18). The shift to SA 19 is performed when a determination of SA 16 becomes Yes by a lapse of the prescribed time period or a determination of SA 18 becomes Yes by receiving all the responses before a lapse of the prescribed time period. In the SA 19, the SVP transmits to all the clusters 1 to which the power supply is indicated on the cluster configuration table 163 a cluster power cut-off notice which is a message for reporting a cut-off of the power (SA 19).

The SVP 11 of the cluster 1-1 receives a cluster power cut-off notice received by SCA 12 (SB 15). Subsequently, the SVP 11 updates the value of supply status information of a corresponding entry of the cluster configuration table 163 as “0” (SB 16). Then, the SVP 11 causes the cluster 1-0 to transmit the response (SB 17). By transmitting the response, a series of processing for responding to the power cut-off in the cluster 1-0 is completed.

The SVP 11 of the cluster 1-0 after transmitting the cluster power cut-off notice, executes processing for responding to the response to be received until the prescribed time lapses (SA 20 to SA 22). The shift to SA 23 is performed when a determination of SA 20 becomes Yes by a lapse of the prescribed time period or a determination of SA 22 becomes Yes by receiving all the responses before a lapse of the prescribed time period.

In SA 23, the SVP 11 executes processing for cutting off the power of the cluster 1-0. With the processing, a system board 152 is instructed to shut down. A series of processing at the time of cutting off the power is completed after confirming the shutdown of the system board 152.

Thus, according to the present embodiment, the cluster 1-0 which cuts off the power, reports to all the currently operating other clusters 1 to cut off the power. The cluster 1-0, when being connected to the HW console 2, cuts off the connection with the HW console 2, updates the console connection status data of the own cluster 1-0, and reports to all the currently operating other clusters 1 that the connection to the HW console 2 has been cut off. Accordingly, the cluster 1 to which these notices are reported may appropriately update data which include the console connection status data stored in each entry of the cluster configuration table 163. As a result, when the cluster 1 being connected to the HW console 2 cuts off the power, any of the currently operating other clusters 1 may handle to the connection with the HW console 2.

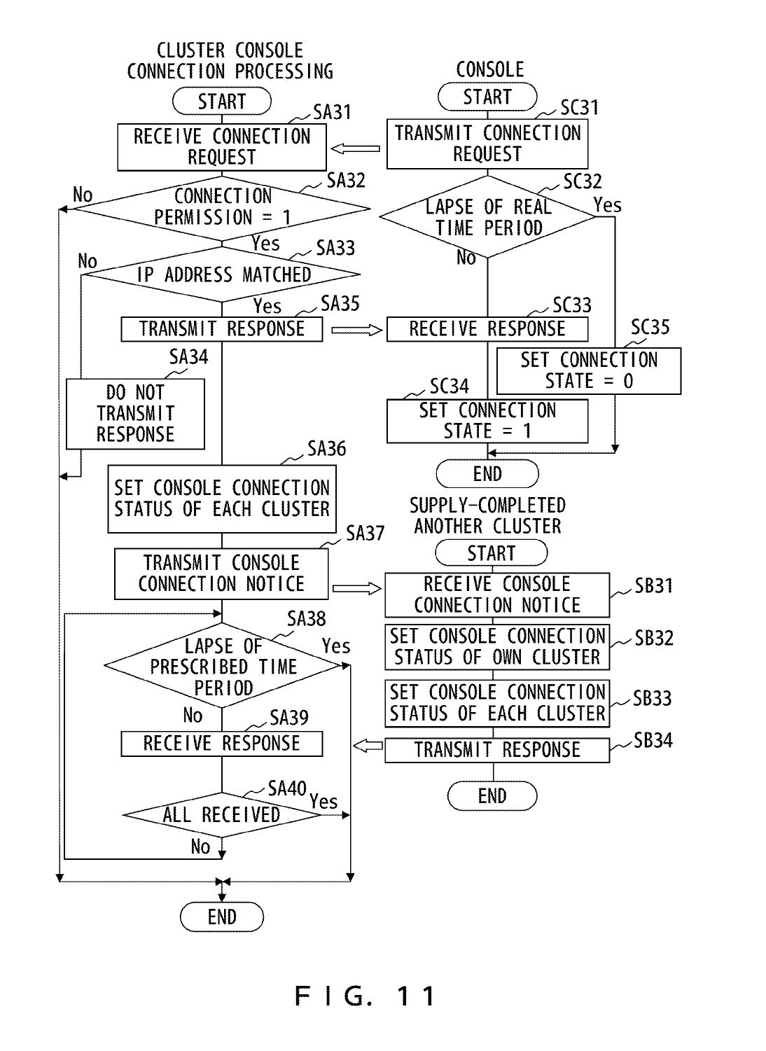

FIG. 11 illustrates a flowchart of console connection processing executed by a cluster for connecting to the HW console. In FIG. 11, in addition to a flowchart of the console connection processing, a flowchart of processing respectively executed by another cluster 1 which does not execute the console connection processing (indicated as “supply-completed another cluster” in FIG. 11) and by the HW console 2 are indicated as well. Subsequently, in reference to FIG. 11, detailed explanations are also described for processing respectively executed by supply-completed (currently operating) another cluster 1 and the HW console 2 when a cluster 1 executes console connection processing.

Here, for the purposes of explanations and conveniences, the cluster 1-0 is assumed as a cluster 1 to execute the console connection processing, and the cluster 1-1 is assumed as supply-completed another cluster 1. Processing of the SVP 11 of the cluster 1-0 illustrated in FIG. 11 is realized mainly by a path switching program 181, for example. Processing of the SVP 11 of the cluster 1-1 is realized mainly by the status update program 185. Processing of the HW console 2 is realized mainly by the LAN communication control program 224.

The present embodiment is based on the premise that the communication between the HW console 2 and the cluster 1 is established by the connection request from the HW console 2. From this, the SVP 11 of the cluster 1 execute the console connection processing when the SVP 11 receives the connection request form the HW console 2. The HW console 2 transmits the connection request to the cluster 1-0 for which the communication is established (SC 31).

The connection request transmitted from the HW console 2 is received by the SCA 12 of the cluster 1-0 and is transferred to the SVP 11 (SA 31). The SVP 11, when it receives the connection request, refers to the console connection status table 171, and determines whether the value of connection permission information in the corresponding console connection status data is “1” (SA 32). When the own cluster 1-0 is in the connection permitted state ST1, the value of the connection permission information is “1”. Accordingly, in this case, a determination of SA 32 becomes Yes and is shifted to SA 33. If it is not so, that is, when the own cluster 1-0 is in the connection not-permitted state ST2, a determination of SA 32 becomes No and a series of processing is terminated. With this, the shift from the connection not-permitted state ST2 to the connected state ST3 is prevented.

In SA 33, the SVP 11 determines whether an IP address in corresponding console connection status data matches up with an IP address of the HW console 2 which is the transmission source of the connection request. When they are matched, a determination of SA 33 becomes Yes and is shifted to SA 35. When they are not matched, a determination of SA 33 becomes No and is shifted to SA 34.

In SA 34, the SVP 11 decides not to transmit the response considering that it has received the connection request from what is not the connection target. After that, a series of processing is terminated. On the other hand, in SA 35, the SVP 11 transmits the response to the transmission source of the connection request, by using the SCA 12.

The HW console 2 after transmitting the connection request executes processing for handling to the response to the connection request (SC 32 to SC 35). With this, the HW console 2, when receiving a response before a lapse of a prescribed time period (Yes in SC 32→SC 33), decides that the communication with the cluster 1-0 has been established and stores “1” as the value of the connection state information 234 (SC 34). On the other hand, when the HW console 2 does not receive a response before a lapse of a prescribed time period (No in SC 32), it stores “0” as the value of the connection state information 234 (SC 35). After updating the connection state information 234, a series of processing related to the connection with the cluster 1-0 is terminated.

The above mentioned SC 31 to SC 35 executed by the HW console 2 correspond to portions that are realized by SC 121, SC 122, and SC 124 in the connection request processing illustrated in FIG. 9. SC 35, although not illustrated in FIG. 9, is executed before shifted to SC 123, for example, when a determination of SC 122 becomes Yes.

The SVP 11 of the cluster 1-0, after causing the HW console 2 to transmit the response, updates the console connection status table 171 and the cluster configuration table 163, deciding that the communication with the HW console 2 has been established (SA 36). With this, the console connection status data of the own cluster 1-0 is updated in accordance with the shift to the connected state ST3, and the console connection status data of another cluster 1 is updated in accordance with the shift to the connection not-permitted state ST2. After that, the SVP 11 transmits a console connection notice, which is a message for reporting that the communication with the HW console 2 has been established, to all the other clusters 1 which recognize a power supply (SA 37).

The SVP 11 of the cluster 1-1 obtains, from the SCA 12, a console connection notice received from the cluster 1-0 (SB 31). The SVP 11, by obtaining the console connection notice, updates the console connection status data on the console connection status table 171 (SB 32), and reflects the update on the cluster configuration table 163 (SB 33). After that, the SVP 11 causes the cluster to transmit the response, the cluster 1-0 being a transmission source of the console connection notice (SB 34). By the transmission of the response, a series of processing related to a shift to the connected state ST3 of the cluster 1-0 is terminated. The console connection status data is updated in accordance with the shift to the connection not-permitted state ST2 of the cluster 1-1.

The SVP 11 of the cluster 1-0 after transmitting the console connection notice, executes processing for handling to the response to be received until the prescribed time period passes (SA 38 to SA 40). The processing is continued until a determination of SA 38 becomes Yes by a lapse of the prescribed time period or a determination of SA 40 becomes Yes by receiving all the responses before a lapse of the prescribed time period. The console connection processing is completed after it is determined Yes in SA 38 or SA 40.

Thus, a cluster 1 which has been shifted to the connected state ST3, reports to the other clusters 1 its shift, and the other clusters 1 update console connection status data for each cluster 1 which includes the own cluster 1 to respond to the notice. Accordingly, under a situation where the cluster 1 in the connected state ST3 exists, all the other clusters 1 become in the connection not-permitted state ST2. With this, two or more clusters 1 may be prevented from becoming a connected state ST3 simultaneously.

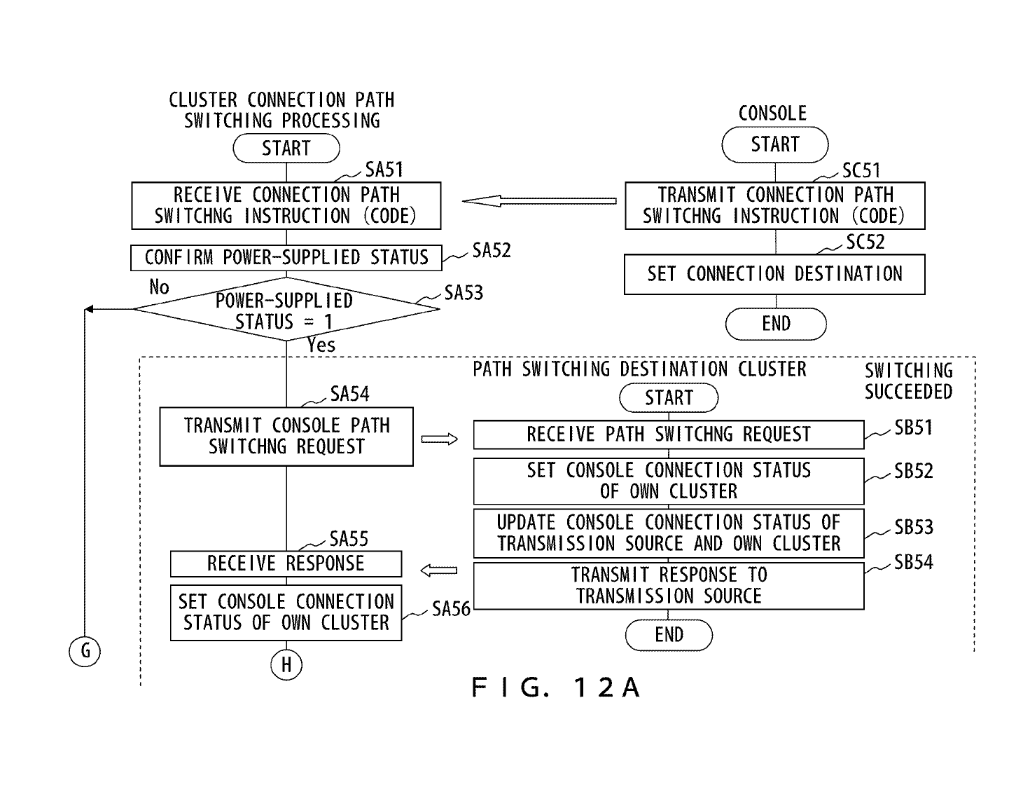

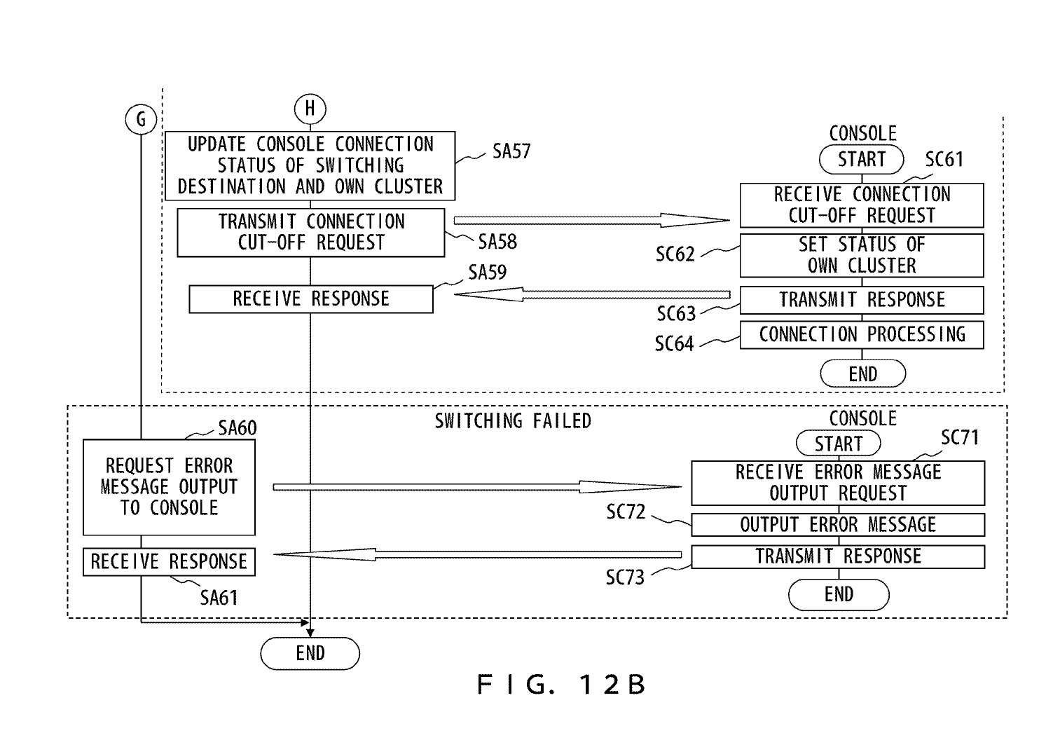

FIGS. 12A and 12B illustrate a flowchart of connection path switching processing executed for the cluster to switch the connection with the HW console. Connection path switching processing is processing executed by the cluster 1 upon receiving the notice from the HW console 2 of a new connection destination to be connected. In FIGS. 12A and 12B, in addition to a flowchart of connection path switching processing, a flowchart of processing executed by the cluster 1 which becomes a new connection destination (indicated as “path switching destination cluster” in FIG. 12A) and a flowchart of processing executed and the HW console 2 are indicated. Subsequently, in reference to FIGS. 12A and 12B, detailed explanations are described for processing respectively executed by the cluster of a new connection destination and by the HW console 2, when one cluster 1 executes connection path switching processing.

Here, for the purposes of explanations and conveniences, the cluster 1-0 is assumed as a first cluster 1 to execute the connection path switching processing, and the cluster 1-1 is assumed as a cluster 1 of a new connection destination. The connection path switching processing illustrated in FIG. 12 is realized mainly by a path switching program 181. Processing of the SVP 11 of the cluster 1-1 is realized mainly by the status update program 185.

Connection path switching processing is executed so as to cause the currently connected cluster 1 to cut off the connection to allow the other clusters 1 to be connected to the HW console 2 newly. Accordingly, the HW console 2 transmits a connection path switching instruction which is a message to instruct a preparation to be connected to the other clusters 1 newly. A code (for example, a cluster number) which indicates a cluster 1 of a new connection destination is added to the connection path switching instruction so that the cluster 1 to be connected newly may be specified.

A newly connected cluster 1 is selected in accordance with the instruction by the operator through the keyboard 250. The output control program 222 executed by the HW console 2 displays a screen switching the cluster 1 of the connection destination. The input control program 223 recognizes the instruction content of the operator by analyzing his operations to the keyboard 250 and delivers a recognition result to the LAN communication control program 224. As a result, the gateway selection control program 227 obtains from the gateway table 212 an IP address for communicating with the cluster 1 in accordance with the instruction of the operator. The connection control program 228 transmits the connection path switching instruction to the currently connected cluster 1. From this, processing of the HW console 2 of the portion illustrated in FIG. 12 is realized mainly by the connection control program 238.

The HW console 2 transmits the connection path switching instruction to the currently connected cluster 1-0 (SC 51). Subsequently, the HW console 2 sets a new connection destination (SC 52). By the setting, a gateway number of the new connection destination is stored as a use gateway number 233. Further, the value of the connection state information 234 is updated as “0”. The update of the use gateway number 233 is performed by the gateway selection control program 227, and the update of the connection state information 234 is performed by the connection control program 238. By changing such settings, a series of processing by the transmission of the connection path switching instruction is terminated.

The connection path switching instruction transmitted from the HW console 2 is received by the SCA 12 of the cluster 1-0 and is delivered to the SVP 11 (SA 51). The SVP 11 specifies a corresponding entry of the cluster configuration table 163 by a code added to the connection path switching instruction and confirms the supply status information of the specified entry (SA 52). Subsequently, the SVP 11 determines whether the value of the supply status information is “1”. When the cluster 1-1 designated by the code is currently operating, the value of “1” is stored in the cluster configuration table 163 as the supply status information of the cluster 1-1. Therefore, when the cluster 1-1 is currently operating, a determination of SA 53 becomes Yes and is shifted to SA 54. When the cluster 1-1 is not currently operating, a determination of SA 53 becomes No and is shifted to SA 60.

In SA 54, the SVP 11 transmits to the cluster 1-1 a path switching request which is a message for requesting the shift to the state in which the connections with the HW console 2 is available.

The SCA of the cluster 1-1 receives a path switching request, and the received path switching request is transferred from the SCA 12 to the SVP 11 (SB 51). The SVP 11 which has received the path switching request updates the console connection status data on the console connection status table 171 for the shift to the connection permitted state ST1 (SB 52), and reflects the update on the cluster configuration table 163 (SB 53). After that, the SVP 11 transmits the response to the cluster 1-0 (SB 54). By the transmission of the response, a series of processing by receiving the path switching request is terminated.

After transmitting the path switching request, the SVP of the cluster 1-0 waits for receiving the response (SA 55). The SVP 11, when the SVP 11 receives the response, updates the console connection status data on the console connection status table 171 for the shift to the connection not-permitted state ST2 (SA 56), and reflects the update on the cluster configuration table 163 (SA 57).

Subsequently, the SVP 11 causes the HW console 2 to transmit a connection cut-off request which is a message for requesting the cut-off of the connection (SA 58). After transmitting the connection cut-off request, the SVP waits for receiving the response (SA 59). By receiving the response, the connection path switching processing is terminated.

The HW console 2 receives the connection cut-off request transmitted from the cluster 1-0 (SC 61). The HW console 2 which has received the connection cut-off request updates the value of the connection state information 234 as “0” (SC 62), and transmits the response to the cluster 1-0 (SC 63). Then, the HW console 2 executes the connection processing for establishing the communications with the cluster 1-1 designated by the operator (SC 64). By executing the connection processing, a series of processing by receiving the connection cut-off request is terminated.

As the connection processing, the HW console 2 executes SC 31 to SC 35 illustrated in FIG. 11. The connection request is transmitted as the gateway selection control program 227 using an IP address obtained from the gateway table 212 by the instruction of the operator. With this, the HW console 2 establishes communications with the cluster 1-1 selected by the operator.

The cluster 1-1 after transmitting the response in SB 54 receives the connection request from the HW console 2 by executing the connection processing in SC 64 of the HW console 2. Explanations for the processing for responding to the connection request are omitted since the detailed explanations therefor have given in FIG. 11.

A determination of No in the above SA 53 means that the HW console 2 has transmitted the connection path switching instruction designating the cluster 1-1 which is not operating currently. From this, in SA 60, the SVP 11 of the cluster 1-0 transmits to the HW console 2 an error message output request which is a message requesting a notice to the operator that the switching of cluster 1 to be connected with the connection path switching instruction is not available. Then, the SVP 11 waits for receiving the response from the HW console 2 (SA 61). By receiving the response, the connection path switching processing is terminated.

The HW console 2 receives the error message output request transmitted from the cluster 1-0 (SC 71). The HW console 2 which has received the error message output request displays on the display 240 an error message for reporting that the connection with the cluster 1-1 instructed by the operator is not available (SC 72). After that, the HW console 2 transmits the response to the cluster 1-0 (SC 73). By transmitting the response, a series of processing by receiving the error message output request is terminated.

By the output of the above mentioned alarm message, the operator may recognize that a connection to the selected cluster 1-1 is not available. Accordingly, the operator may immediately start the operations targeting for the other clusters 1-1.

The output of the alarm message is performed by the output control program 222 with the request from the data transmission/reception control program 226. Data of the alarm message to be output is generated by using character pattern information 232, for example.

As mentioned above, the present embodiment is configured such that the cluster 1 currently connected to the HW console 2 cuts off the connection with the HW console 2 after making the cluster 1 designated by a code shift to a connectable state with the HW console 2. The reason that the connection is cut off in such a procedure is to confirm whether the cluster 1 may be connected to the HW console 2 by the communication with the cluster 1 designated by a code, and to reflect the confirmation result on the cut-off of the connection. By adopting this procedure, when the cluster 1 designated by the code may not be connected to the HW console 2 due to power cut-offs, failures, or the like, other clusters 1 may be made to prepare for the connections through the currently connected cluster 1.

Processing of the above mentioned SA 54 to SA 59, processing of the cluster 1-1 and the HW console 2 by the SA 54 to the SA 59 are executed at the time of successful switching in which the connection path switching instruction could be normally processed. Processing of the above mentioned SA 60 to SA 61 and processing of the HW console 2 by the SA 60 to the SA 61 are executed at the time of unsuccessful switching.

However, as mentioned above, the cluster 1-1 which has transmitted the path switching request may not normally operate. In such cases, the cluster 1-1 does not transmit the response. Accordingly, the SVP 11 of the cluster 1-0, when the SVP 11 does not receive the response before a lapse of the prescribed time period in SA 55, reports so to the HW console 2 and maintains the connected state ST3. SA 56 to SA 59 are not executed. Thus, a state that may handle to the reception of the subsequent path switching instruction is maintained.

The cluster 1-0 which cuts off the connection with the HW console by receiving the connection path switching instruction does not report this to the other clusters 1. This is because the cluster 1-1 which is connected to the HW console 2 subsequently reports the connection to the other clusters 1. The notice means that the connection of the cluster 1-0 is cut off. This means that the cluster 1 which cuts off the connection does not always need to report the cut-off of the connection to the other clusters 1.

It is possible that the HW console 2 does not operate normally. There may be cases in which the HW console 2 does not operate normally, due to power cut-offs, failures, or the like. From this, the present embodiment is configured to let the cluster 1 currently connected monitor whether it may communicate with the HW console 2, as needed. With this, when the cluster 1 is confirmed to be unable to communicate with the HW console 2, all the currently operating clusters are made to shift to the connection permitted state ST1.

As all the currently operating clusters 1 are shifted to the connection permitted state ST1, the HW console 2, when it is restored to a normally operating state, may connect to every cluster 1. With this, when the HW console 2 has come to operate normally, the operator may readily connect the HW console 2 to a desired cluster 1 and accordingly, a decline in work efficiency and the like may be prevented.

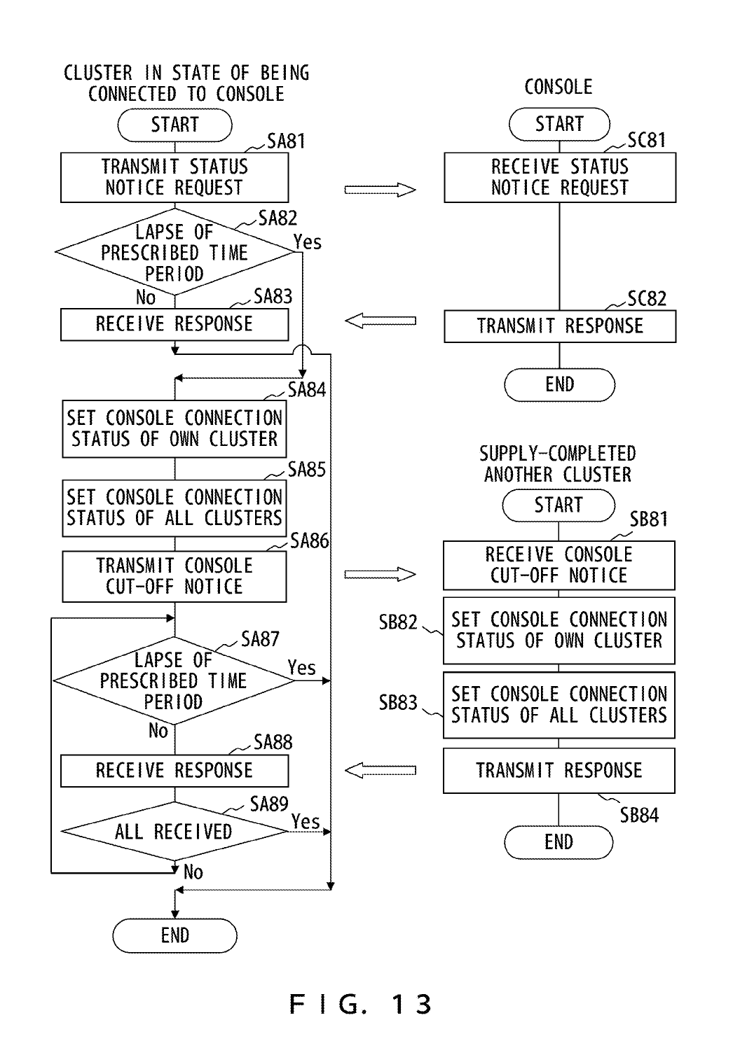

FIG. 13 illustrates a flowchart of console monitoring processing. Console monitoring processing is processing to be executed for monitoring whether a cluster 1 currently connected to the HW console 2 (indicated as “cluster in state of being connected to console” in FIG. 13) may perform communications with the HW console 2, and the console monitoring processing is executed, for example, with the predetermined timing. More specifically, the console monitoring processing is executed when the communications with the HW console 2 are not performed for a prescribed time period or over, for example.

In FIG. 13, in addition to a flowchart of console monitoring processing, a flowchart of processing respectively executed by the HW console 2 and the other clusters 1 not currently connected are illustrated as well. Subsequently, in reference to FIG. 13, detailed explanations are described for processing respectively executed by the HW console 2 and the other clusters 1 as well when the currently connected cluster 1 executes console monitoring processing. Here, for the purposes of explanations and conveniences, the cluster 1-0 is assumed as a cluster 1 to execute the console monitoring processing, that is, as a first cluster 1, and the cluster 1-1 is assumed as the other clusters 1. The console connection monitoring processing illustrated in FIG. 13 is realized mainly by a console communication state monitoring program 184. Processing of the SVP 11 of the cluster 1-1 is realized mainly by the status update program 185.

First, the SVP 11 of the cluster 1-0 transmits to the HW console 2 a status notice request which is a message used for confirming the operation state (SA 81).

The HW console 2, when normally operating, receives the transmitted status notice request (SC 81) and transmits the response (SC 82).

The SVP 11 of the cluster 1-0, after transmitting the status notice request, waits until the HW console 2 receives a response during a lapse of a prescribed time period (SA 82, SA 83). With this, when the HW console 2 receives a response before a lapse of a prescribed time period after transmitting the status notice request (No in SA 82→SA 83), the HW console 2 is considered being operating normally and the console monitoring processing is completed here. On the other hand, when the HW console 2 does not receive a response before a lapse of a prescribed time period after transmitting the status notice request (Yes in SA 82), the HW console 2 is considered not being operating normally and is shifted to SA 84.

In SA 84, the SVP 11 updates the console connection status data on the console connection status table 171 in order to make it shift to the connection permitted state ST1. Subsequently, the SVP 11 reflects the update on the cluster configuration table 163 (SA 85). After that, the SVP 11 transmits the console cut-off notice which is the message for reporting that the connection with the HW console 2 has been cut off, to all the clusters 1 that may be confirmed as being currently operating from the cluster configuration table 163 (SA 86).

The SVP 11 of the cluster 1-1 after transmitting the console cut-off notice, executes processing for responding to the response to be received until a lapse of the prescribed time (SA 87 to SA 89). The processing is continued until a determination of SA 87 becomes Yes by a lapse of the prescribed time period or until a determination of SA 89 becomes Yes by receiving all the responses before a lapse of the prescribed time period. The console monitoring processing is completed after it is determined Yes in SA 87 or SA 89.

The SVP 11 of the cluster 1-1 not currently connected to the HW console 2 receives a console cut-off notice received from the cluster 1-0 through the SCA 12 (SB 81). The SVP 11, by receiving the console cut-off notice, updates the console connection status data on the console connection status table 171 for the shift to the connection permitted state ST1 (SB 82), and reflects the update on the cluster configuration table 163 (SB 83). After that, the SVP 11 transmits the response to the cluster 1-0 (SB 84). By transmitting the response, a series of processing by receiving the console cut-off notice is completed.

Thus, the cluster 1 currently connected to the HW console 2 confirms whether the HW console 2 normally operates, and when the HW console 2 does not normally operate, the cluster 1 makes all the currently operating clusters 1 shift to the connection permitted state ST1. Accordingly, the HW console 2 restored to a normally operating state may be connected to any of the clusters 1.

It is possible that the cluster 1 does not normally operates including the cluster 1 currently connected to the HW console 2. When the cluster 1 which is currently connected to the HW console 2 does not normally operate or fails to communicate with other clusters 1 for some reasons, all the other currently operating clusters are in a connection not-permitted state ST2. Accordingly, in such a case, the operator finds it impossible to connect the HW console 2 to the other cluster 1. From this, the present embodiment is configured to cause the cluster 1 not connected to the HW console 2 to monitor whether such a situation has occurred. With this, when such a situation has occurred, all the currently operating clusters 1 are made to shift to the connection permitted state ST1. With this shift, the HW console 2 may be prevented from being unable to be connected to the cluster 1, and accordingly, the computer system may perform more stable operations.

The cluster 1 currently connecting to the HW console 2 needs to perform processing in accordance with the request from the HW console 2. Accordingly, it is highly likely that the load of the cluster 1 currently connected to the HW console 2 gets heavier than the cluster 1 which is not connected to the HW console 2. From this, the present embodiment is configured to cause the cluster 1 not connected to the HW console 2 to perform the above mentioned monitoring. The monitoring may be performed by a cluster 1 which is currently connected to the HW console 2.

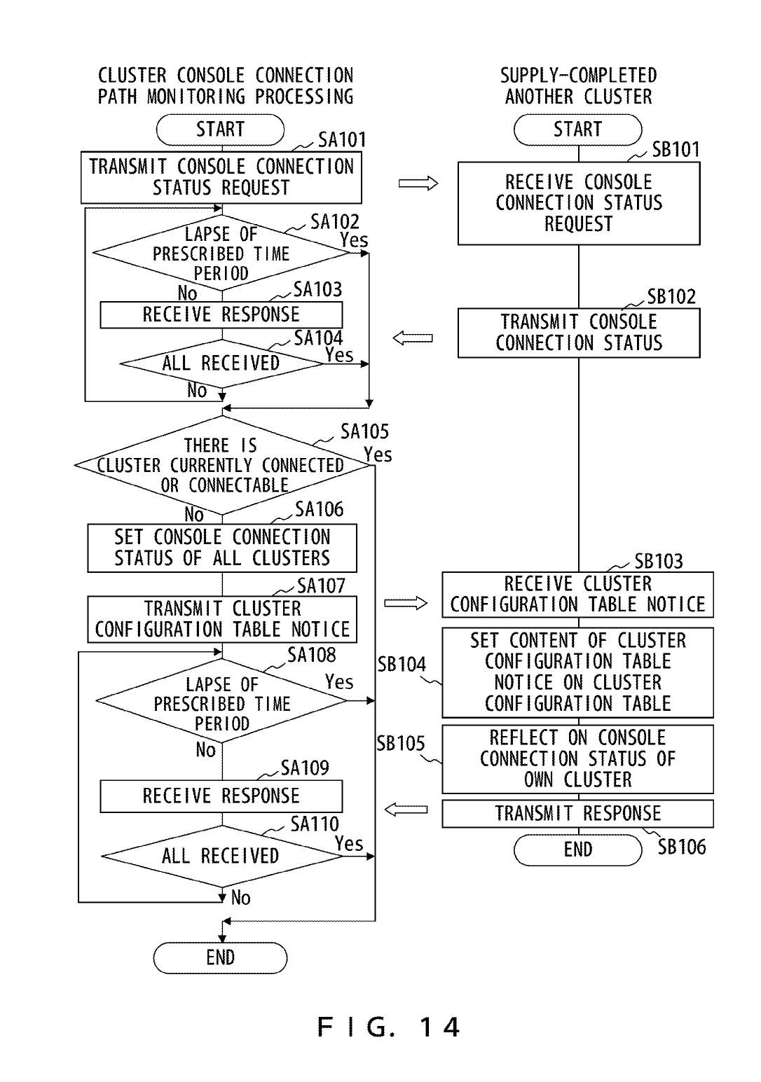

FIG. 14 illustrates a flowchart of console connection path monitoring processing. Console connection path monitoring processing is processing executed by a cluster 1 which is not connected to the HW console 2 for monitoring the operation status of other clusters 1 recognized as being currently operating and is executed in a prescribed timing. More specifically, in the console connection path monitoring processing, any of the clusters 1 not connected to the HW console 2 is executed for example every lapse of a predetermined time period. In order to avoid that the execution frequency greatly differs in accordance with clusters 1, it is desirable that the console connection path monitoring processing is executed by the cluster 1 with a small execution frequency or by a cluster 1 with a long lapse of time after executing the console connection path monitoring processing.

In FIG. 14, in addition to a flowchart of a console connection path monitoring processing, a flowchart of processing executed by the currently operating another cluster 1 (indicated as “supply-completed another cluster” in FIG. 14) is indicated as well. Subsequently, in reference to FIG. 14, detailed explanations are described for processing executed by the other clusters 1 as well when one cluster 1 executes console connection path monitoring processing. Here, for the purposes of explanations and conveniences, the cluster 1-0 is assumed as a cluster 1 to execute the console connection path monitoring processing, and the cluster 1-1 is assumed as the other clusters 1. The console connection path monitoring processing illustrated in FIG. 14 is realized mainly by a console connection path monitoring program 183. Processing of the SVP 11 of the cluster 1-1 is realized mainly by the status update program 185.

First, the SVP 11 of the cluster 1-0 transmits a console connection status request which is a message for requesting to all the other clusters in which a power supply may be confirmed on the cluster configuration table 163 to transmit console connection status data (SA 101). After that, the SVP 11 executes the processing for handling to the response received until a lapse of the prescribed time period (SA 102 to SA 104). The processing is continued until a determination of SA 102 becomes Yes by a lapse of the prescribed time period or until a determination of SA 104 becomes Yes by receiving all the responses before the lapse of the prescribed time period. When it is determined as Yes in SA 102 or SA 104, the step is shifted to SA 105.

The SVP 11 of the cluster 1-1 to which the console connection status request has been transmitted receives a received console connection status request through the SCA 12 (SB 101). The SVP 11, by receiving the console connection status request, transmits the console connection status data of the own cluster 1-1 stored in the console connection status table 171 by adding it to the response (SB 102).

The SVP 11 of the cluster 1-0 which has transmitted a console connection status request may recognize the communication state of each cluster 1 which has transmitted the response. In SA 105, the SVP 11 determines from the received response whether a currently connected or connectable cluster 1 exists. That no cluster 1 in the connected state ST3 or in the connection permitted state ST1 exists means that no cluster 1 currently connected to the HW console 2 exists and that no cluster 1 connectable to the HW console 2 exists. From this, when no cluster 1 in the connected state ST3 or in the connection permitted state ST1 exists, a determination of SA 105 becomes No and is shifted to SA 106. When a cluster 1 in the connected state ST3 or in the connection permitted state ST1 exists, a determination of SA 105 becomes Yes and here, the console connection path monitoring processing is terminated.

In SA 116, the SVP 11 updates console connection status data of the own cluster 1-0 for setting the connection permitted state ST1, and updates the cluster configuration table 163 in which the setting of the connection permitted state ST1 of each cluster 1 which received the response is assumed. Subsequently, the SVP 11 transmits to all the clusters 1 that received the response a cluster configuration table notice which is a message to which console connection status data of each cluster 1 stored in the updated cluster configuration table 163 is added (SA 107).

After that, the SVP 11 executes processing for handling to the response received until the lapse of a prescribed time period (SA 108 to SA 110). The processing is continued until a determination of SA 108 becomes Yes by a lapse of the prescribed time period or until a determination of SA 110 becomes Yes by receiving all the responses before a prescribed time period passes. After being determined as Yes in SA 108 or SA 110, the console connection path monitoring processing is completed.

The SVP 11 of the cluster 1-1 to which the cluster configuration table notice is transmitted receives the received cluster configuration table notice (SB 103). The SVP 11 stores all the console connection status data added to the cluster configuration table notice in the cluster configuration table 163 (SB 104). Subsequently, the SVP 11 reflects the console connection status data of the own cluster 1-1 on the console connection status table 171 (SB 105). After that, the SVP 11 transmits the response to the cluster 1-0 (SB 106). By transmitting the response, a series of processing for responding to the execution of the console connection path monitoring processing by the SVP 11 of the cluster 1-0 is terminated.

Thus, the present embodiment is configured to make all the currently operating clusters 1 forcibly shift to the connection permitted state ST1, when the HW console 2 becomes in a state of being not connected to the cluster 1. As a result, the operator may continue operations targeting the other clusters 1 even when the currently connected cluster 1 does not normally operate.

In clusters 1, there are some cases where information to be reported to the operator of the HW console 2 might be generated. For example, when failures or errors are generated, it is necessary to let the operator recognize these. From this, the present embodiment is configured to cause the cluster 1 in which information to be reported to the operator is generated to transmit the alarm message output request which is the message for reporting to the operator the information content, to the HW console 2.

It is only one cluster 1 that is in a status being communicable to the HW console 2 in the cluster 1 side. The unconnected cluster 1 does not transmit the alarm message output request directly to the HW console 2. From this, in the present embodiment, the unconnected cluster 1 is configured to let the alarm message output request transmit through the connected cluster 1. Thus, by transferring the alarm message output request through the connected cluster 1, all the clusters 1 may transmit to the HW console 2 the alarm message output request, as required, in a timely manner.

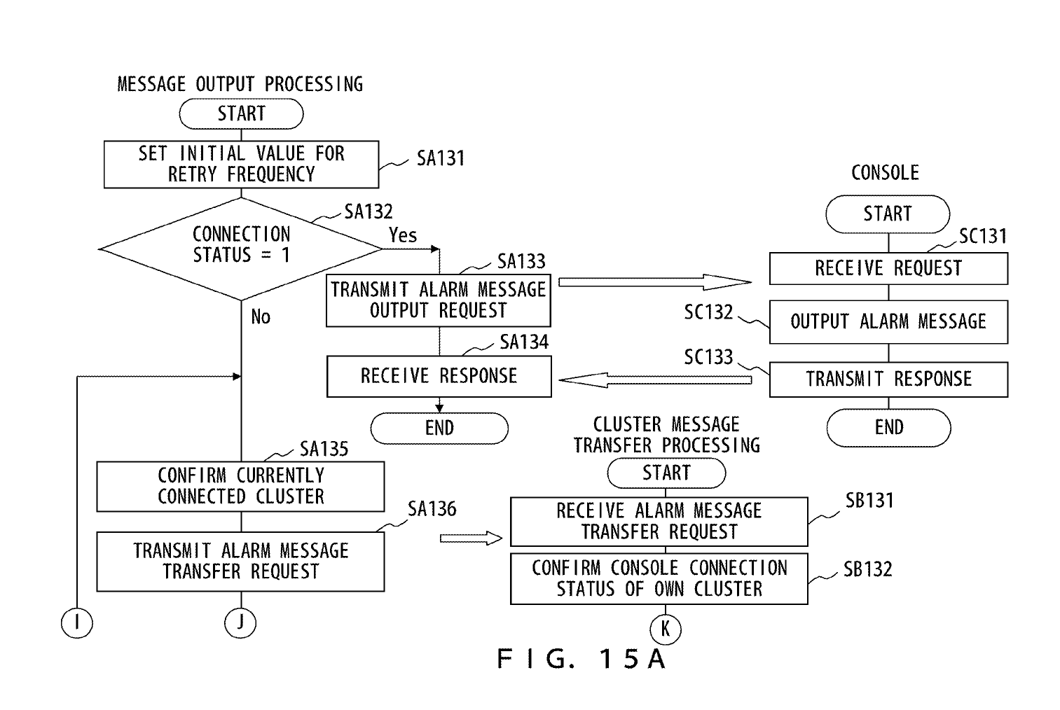

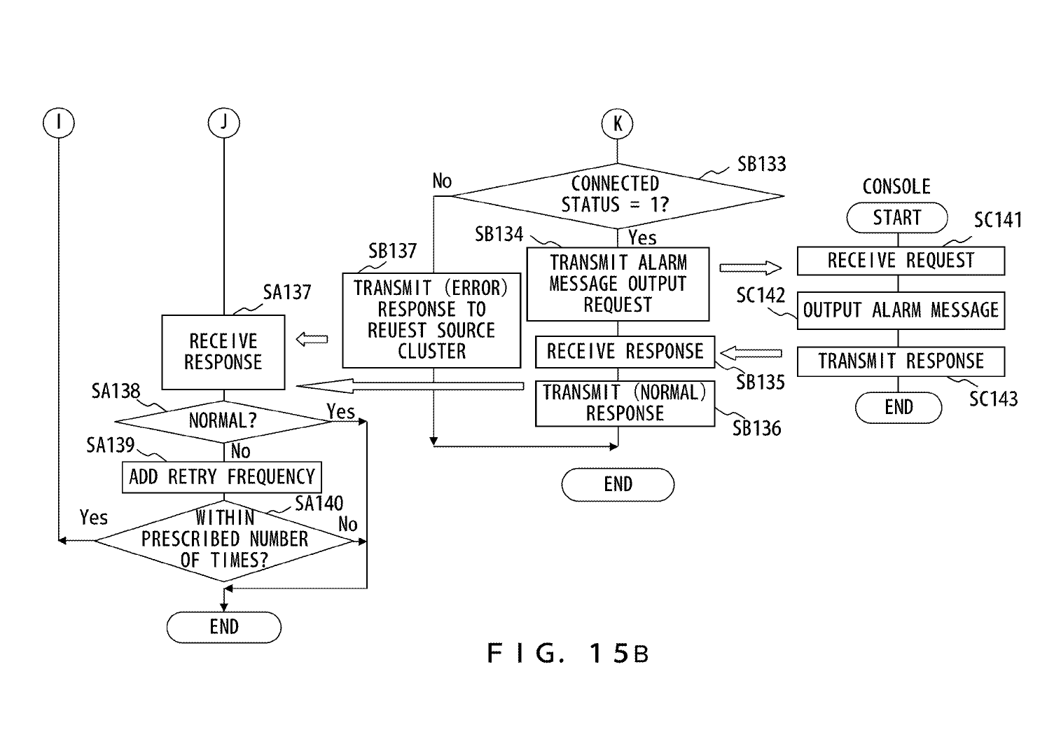

FIGS. 15A and 15B illustrate a flowchart of alarm message output processing. Alarm message output processing is processing executed for transmitting the alarm message output request either directly or indirectly to the HW console 2 when the alarm message output request to be transmitted to the HW console 2 occurred. By executing the alarm message output processing, the cluster 1 may transmit necessary pieces of data to the HW console 2, either directly or indirectly.

In FIGS. 15A and 15B, in addition to a flowchart of an alarm message output processing, a flowchart of message transfer processing executed by cluster 1 currently connected to the HW console 2 and processing executed by the HW console 2 are indicated as well. Message transfer processing is processing executed for transferring the alarm message output request to the HW console 2 by the request from the unconnected cluster 1. Finally, in reference to FIGS. 15A and 15B, detailed explanations are described for processing respectively executed by the connected cluster 1 and the HW console 2 when the unconnected cluster 1 executes the alarm message output processing.

Here, for the purposes of explanations and conveniences, the cluster 1-0 is assumed as a cluster 1 to execute the alarm message output processing, and the cluster 1-1 is assumed as the other clusters 1 to execute the message transfer processing. The alarm message output processing illustrated in FIGS. 15A and 15B is realized mainly by a message transfer program 161. Similarly, the message transfer processing executed by the SVP 11 of the cluster 1-1 is realized mainly by the message transfer program 161. The processing executed by the HW console 2 is realized mainly by the data transmission/reception control program 226.

First, the SVP 11 of the cluster 1-0 which is in the situation to transmit the alarm message output request sets (substitutes) an initial value in a retry frequency (SA 131). A retry frequency is a variable for counting the frequency for asking the other clusters 1 to transfer the alarm message output request and the initial value is, for example, “0”. In the present embodiment, the frequency for asking the transfer by counting the frequency of a transfer request has a predefined upper limit.

Subsequently, the SVP 11 determines whether the value of connection status information of the console connection status data of the own cluster 1-0 is “1”. When the cluster is connected to the HW console 2, “1” is set as the value of the connection status information. Accordingly, when the cluster is connected to the HW console 2, a determination of SA 132 becomes Yes and is shifted to SA 133. When the cluster is not connected to the HW console 2, a determination of SA 133 becomes No and is shifted to SA 135.

In SA 133, the SVP 11 transmits to the HW console 2 the alarm message output request. Subsequently, the SVP 11 waits for the response received from the HW console 2 (SA 134). After receiving the response, the alarm message output processing is terminated.

The HW console 2 to which the alarm message output request is transmitted receives the alarm message output request (SC 131). The HW console 2 which has received the alarm message output request outputs the alarm message specified by the alarm message output request on the display 240 (SC 132). After that, a series of processing related to the reception of the alarm message output request is terminated.

The output of the alarm message is performed by the output control program 222 with the request from the data transmission/reception control program 226. The data of the output alarm message is generated for example by using character pattern information 232.

The SVP 11 of the cluster 1-0 which is shifted to SA 135 as a result that a determination of the above SA 132 becomes No refers to the cluster configuration table 163 and confirms the cluster 1-1 which is currently connected to the HW console 2. Subsequently, the SVP 11 transmits the confirmed the cluster 1-1 an alarm message transfer request which is a message for requesting the transfer of the alarm message output request (SA136). The alarm message output request is transmitted to the cluster 1-1 after being added to the alarm message transfer request.

The SVP 11 of the cluster 1-1 receives from the SCA 12 an alarm message transfer request received by the SCA 12 (SB 135). The SVP 11, when it has received the alarm message transfer request, confirms console connection status data of the own cluster 1-1 (SB132) and determines whether the value of connection status information is “1” (SB133). When the value of connection status information is “1”, that is, when the own cluster 1-1 is currently connected to the HW console 2, a determination of SA 133 becomes Yes, and is shifted to SB 134. When the value of connection status information is not “1”, a determination of SA 133 becomes No, and is shifted to SB 137.

In SB 134, the SVP 11 causes the HW console 2 to transmit an alarm message output request which is added to the alarm message transfer request. The SVP 11 which has caused the HW console 2 to transmit the alarm message output request waits for the response from the HW console 2 (SB 135). The SVP 11, when it receives the response, transmits to the cluster 1-0 the response in which a completion status is stored, the completion status indicating that a transfer of the alarm message output request has been normally completed (SB 136). By transmitting the response, the message transfer processing is completed.

On the other hand, in SB 137, the SVP 11 transmits to the cluster 1-0 the response in which a completion status is stored, the completion status indicating that an error has occurred in transferring the alarm message output request. By transmitting the response, the message transfer processing is completed.

The SVP 11 of the cluster 1-0, after transmitting an alarm message transfer request, waits for the response from the cluster 1-1 (SA 137). When receiving the response, the SVP 11 determines whether a completion status of the received response indicates normality (SA 138). When the completion status indicates normality, a determination of SA 138 becomes Yes, and alarm message output processing is completed here. When the completion status does not indicate normality, a determination of SA 138 becomes No, and is shifted to SA 139.

In SA 139, the SVP 11 adds “1” to a retry frequency. Subsequently, the SVP 11 determines whether the retry frequency is within the predetermined frequency (SA 140). When the retry frequency is within the predetermined frequency, that is, when the frequency of asking a transfer of an alarm message output request to the other clusters 1 by transmitting an alarm message transfer request does not reach the upper limit, a determination of SA 140 becomes Yes and goes back to the above SA 135. With this, the alarm message transfer request is transmitted once again. On the other hand, when the retry frequency is larger than the prescribed frequency, a determination of SA 140 becomes No, and the message output processing is terminated here.

Thus, the cluster in a situation to transmit the alarm message output request transmits the alarm message output request either directly or indirectly to the HW console 2 in accordance with whether the cluster 1 is currently connected to the HW console 2. With this, the operator may grasp the state and the like of each cluster 1 during operations in a timely manner regardless of whether the cluster 1 is connected to the HW console 2.

In the present embodiment, although each cluster 1 recognizes communication states of the other clusters 1, respectively, and shifts the communication states of the own cluster 1, the cluster 1 which recognizes the communication states of each cluster 1 may be restricted. Namely, the present embodiment may be configured to recognize the communication states of each cluster 1 and prepare one or more clusters 1 to manage the shift of the communication states of the other clusters 1. This means that the control to shift the communication states may be performed by either of a notice transmitting side or a notice receiving side.

Further, the recognition of the HW console 2 and the currently connected cluster 1 is performed by a notice at the time of being shifted to the connected state ST3 and a notice at the time of being shifted from the connected state ST3 to the connection permitted state ST1 under the situation where the normal operations of the HW console 2 may not be confirmed. However, the timing of transmitting the notice, the order of transmitting the notice, or the like is not restricted to the present embodiments. Various modifications may be applied to these.

Therefore, the number of computers capable of communicating with the data processing device simultaneously may appropriately be restricted even when no computer normally operates any longer, when a data processing device and a plurality of computers are connected to a network.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for establishing a communication between a plurality of computers and a data processing device through a network, the method comprising:
reporting, when a change occurs in a communication state between the plurality of computers and the data processing device, the change in the communication state to another computer;
recognizing, from among the plurality of computers, a computer which establishes a communication with the data processing device, based on a notice of the change in the communication state; and
establishing, when a number of computers for which each of the plurality of computers recognizes to have established a communication with the data processing device is not greater than a predetermined prescribed number, a communication with the data processing device, with a request from the data processing device.

2. The method for establishing a communication according to claim 1, wherein
a computer which establishes a communication with the data processing device monitors whether the data processing device normally operates, and reports to another computer, when determining that the data processing device does not normally operates by the monitoring, that a communication with the data processing device is terminated.

3. The method for establishing a communication according to claim 1, wherein
the computer confirms a communication state of another computer, and makes another computer shift the communication state on the basis of a result of the confirmation.

4. The method for establishing a communication according to claim 1, wherein
a computer which does not establish a communication with the data processing device, when data to be transmitted to the data processing device is generated, requests a computer which establishes a communication with the data processing device to transfer the data to be transmitted to the data processing device, and a computer which establishes a communication with the data processing device transfers to the data processing device the data to be transmitted by the request.

5. A computer system including a plurality of computers and a data processing device connected to the computers through a network, wherein the computers comprising:
a recognition unit configured to recognize another computer which establishes a communication with the data processing device; and
a management unit configured to manage a communication with the data processing device by the plurality of computers on the basis of a recognition result of the recognition unit and restrict a number of first computers which communicate with the data processing device simultaneously from among the plurality of computers.

6. A computer communicable through a network, the computer comprising:
a recognition unit configured to recognize another computer which establishes a communication with a data processing device when another computer and the data processing device are connected to the network; and
a communication control unit configured to perform a communication with the data processing device on the basis of a recognition result of the recognition unit.
